(19) United States
(12) Patent Application Publication
(10) Pub. No.: US 2018/0317706 A1
(43) Pub. Date: Nov. 8, 2018

(54) VERTICAL BARREL COOKER FOR EVEN-TEMPERATURE COOKING AND RELATED METHODS

(71) Applicant: Barrel House Cooker, LLC, Bakersfield, CA (US)

(72) Inventors: Brian Graves, Bakersfield, CA (US); Crispin Mercado, Bakersfield, CA (US)

(73) Assignee: Barrel House Cooker, LLC, Bakersfield, CA (US)

(21) Appl. No.: 15/973,312

(22) Filed: May 7, 2018

Related U.S. Application Data
(63) Continuation-in-part of application No. 29/603,303, filed on May 8, 2017.
Application No. 29/603,303 is a continuation-in-part of application No. 29/607,925, filed on Jun. 16, 2017.
(60) Provisional application No. 62/503,318, filed on May 8, 2017.
(60) Provisional application No. 62/579,152, filed on Oct. 31, 2017.

(51) Int. Cl. A47J 37/07; A23L 5/10

(52) U.S. Cl. CPC A47J 37/0718; A23V 2002/00; A23L 5/10

(57) ABSTRACT

The present invention provides improved outdoor cooking systems and methods in various styles for cooking food in an efficient and consistent manner, with little required monitoring or action by the user. Embodiments of the cooker of the present invention include an upper cooking vessel which may be removably engaged with a separate base, a removable fuel basket, and a bottom air intake opening having a diffuser cap above it that not only disperses incoming air flow to the perimeter of the vessel for a more even burn and consistent cooking chamber temperature, but also directs ash and drippings from the food being cooked away from the intake opening. This prevents the intake opening from being clogged, and makes the drippings available for evaporation to provide moisture inside the cooker. The intake opening is adjustable allowing a user to control the amount of air flowing into the cooking chamber.

### PRIORITY CLAIM

This application claims the benefit of: (1) U.S. Provisional patent application No. 62/503,318 filed on May 8, 2017; (2) U.S. Provisional patent application No. 62/579,152 filed on Oct. 31, 2017; (3) U.S. Design patent application No. 29/603,303 filed on May 8, 2017; and (4) U.S. Design patent application No. 29/607,925 filed on Oct. 31, 2017, all four of which are incorporated herein in their entirety by this reference.

### FIELD OF THE INVENTION

The present invention relates to the field of outdoor cooking apparatuses. More specifically, the invention provides a barrel-style cooker that is capable of providing an even and consistent internal temperature for cooking meats and other foods, and related methods.

### DISCUSSION OF THE BACKGROUND

Upright barrels have been used to fabricate cookers for generations. This is due to barrels being readily available and inexpensive, and providing a convenient and effective cooking vessel that can be used to smoke and cook with little alteration. However, conventional barrel cookers have various flaws that result in uneven cooking, limited applications (e.g., due to crude cooking surface located close to the heat source), and hazards to the user. Rudimentary barrel cookers utilize charcoal, wood, or other solid fuels and require constant supervision due to the uneven and fluctuating burn of the fuel, which results in inconsistent heat while cooking or smoking foods.

Conventional solid fuel cooking systems do not produce heat consistently across the fuel and the amount of total heat per unit time produced by the fuel fluctuates. Adjustable air vents may be included in such systems to set the amount of air that may be allowed to pass into the system. However, the placement of the air vents may be such that there is turbulent and uneven air flow. Usually the air vents are in an off-center location to avoid the chimney effect that results from placing the vents in the center of the cooking vessel, where the air flow through the cooker rises in a narrow vertical column through the cooker, preventing the even flow of heat in the cooking vessel. Additionally, insufficient air flow can result in insufficient heat and excessive air flow can result in excessive heat and pre-mature consumption of the fuel source. Thus, conventional cooking systems are quite imprecise and variable in the internal temperatures that they generate and the efficiency with which they consume fuel.

It is even more difficult to maintain fuel and consistent temperatures in conventional smokers because smoking requires several hours of cooking time. The fuel and the level of heat produced by conventional smokers must be monitored and maintained throughout the cooking time. Conventional smoking systems typically have a side door to allow the user to regularly refuel or stoke the fire. Such systems cannot maintain a constant elevated temperature without sustained attention to the fuel and its burn.

Additionally, conventional barrel cookers have a solid and non-removable bottom surface (the bottom of the barrel). Fuel ash generated by the cooking process is essentially trapped in the bottom of the barrel smoker without modifications to the barrel. Conventional modifications to such barrel cookers include air vents located in the sidewall of the barrel to allow access to the bottom of the barrel for adding fuel and retrieving fuel ash. Cleaning the fuel ash out of the cooking vessel is often strenuous because the user must reach into the vessel and retrieve the ash through an access door, or the user must overturn the entire vessel to dump the ash. This is also a problem for other conventional outdoor cookers (e.g., barbeques, kettle cookers, etc.)

Other conventional cookers (e.g., barbeques, kettle cookers, etc.) often have air vents located off-center in the bottom surface of the cooking vessel. In such locations, the air vents are quickly obstructed by fuel ash. Even if the user regularly cleans the fuel ash out of the vessel, the intake vents can become obstructed during a single cooking session.

Various versions, improvements and changes have been made to outdoor cooking systems over recent decades, however, improvement is still needed in such systems.

### SUMMARY OF THE INVENTION

The present invention provides improved outdoor barrel-style cooking systems that are operable to cook in various styles in an efficient and consistent manner, with little required monitoring or action by the user. Embodiments of the present invention may include a direct and unobstructed heat source that provides consistent heat to the interior of a semi-pressurized chamber. Embodiments of the present invention may utilize a centrally located bottom air intake having a diffuser cap that not only disperses air flow to the perimeter of the coal basket for a more even coal burn and consistent cooking chamber temperature, but also directs ash and drippings from the food being cooked away from the opening. This prevents the opening from being clogged, and makes the drippings available for evaporation to provide moisture inside the cooker. The opening is adjustable allowing a user to control the amount of air flowing into the cooking chamber.

The flow of heat and air through the chamber is controlled such that it flows up from the floor of the cooking vessel and in proximity to the sidewall to create a symmetrical thermal column flow that distributes heat evenly in the vessel. As a result of the symmetrical and uniform air and heat flow, the temperature in the interior of the chamber may be maintained in a consistent range and the moisture and smoke generated therein may also be maintained in the chamber. The cooking system may use various fuels as a heat source to generate convection heating within a chamber. The presently disclosed system minimizes temperature variation (including excessive heat, flame damage, etc.), moisture loss, and excessive cooking.

In embodiments of the invention, a vertical and cylindrical cooking chamber mates to a separate base. In these embodiments, the base is comprised of an adjustable air intake system, a diffuser cap, a removably positioned charcoal basket, and legs which may be affixed to the exterior of the cooker base. The cooker base includes an important upward facing rim on its perimeter that engages a lower end of the vertical cylindrical cooking chamber, and is sufficiently tall to keep the cylindrical cooking chamber from dislodging from the base. The upward facing rim on the cooker base perimeter dually serves as a retainer and containment system for food drippings, debris and ash yielded from the cooking process.

Embodiments of the chamber may be a drum or barrel-like cylindrical structure in which meats and other foods may be suspended by hook, grill, or other methods at various levels within the column of the chamber. In some embodiments, and without limitation, the chamber may include perimeter shapes that are not circular, such as polygonal shapes (e.g., square, pentagonal, hexagonal, heptagonal, octagonal, nonagonal, decagonal, etc.), and other practical perimeter shapes.

Embodiments of the system may include a separate base that provides support structures (e.g., legs) that contact the ground and a centrally positioned air intake. In these embodiments, the base engages with the bottom of the barrel structure when the cooker is in use. In preferred embodiments, the separate base may nest with the outer edge of the barrel structure, and the barrel structure may have an outer rim at its bottom that has an internal diameter that is greater than the outer diameter of the separate base. For example and without limitation, the difference in diameters may be between about 2 mm and about 10 mm. In these embodiments, the base may have an outer cylindrical wall or rim at its perimeter that acts as the weight bearing contact point for receiving the barrel structure, and also creates a basin in the base.

In these embodiments, the barrel may rest on the outer cylindrical wall of the base, such that the barrel portion can be easily centered and engaged with the cylindrical wall of the base when in use, and easily removed for access to the interior of the base and coal basket. The barrel may have a sloped annular flange positioned on the inner side of the sidewall of the barrel at the lower end of the barrel for engagement against the upwardly extending cylindrical rim of the base. In some embodiments, and without limitation, the sloped annular flange may be sloped downward relative to the horizontal at an angle in a range of about −10° to about −60° (e.g., about -−5° to about −45°, or any other value or range of values therein). In some examples, the barrel portion may further include an annular gasket that is attached to the bottom side of the sloped annular ring to provide a contact surface or seal for the cylindrical wall of the separate base. The annular gasket may be a polymeric or composite material having sufficiently high heat resistance to prevent deterioration of the gasket for an extended period of use. For example, the gasket material may be vulcanized rubber, fluoro-silicone rubber, polysiloxane, a composite of polymer (e.g., nitrile, carboxylated nitrile, chloroprene, etc.) and a ceramic (e.g., aluminosilicates, etc.), and other polymer or composite heat-resistant materials.

In some embodiments, the connection between the separate base and the barrel portion may be snug, but it may not necessarily be locked into position by a latch or other securing mechanism. Thus, the barrel portion can be quickly and easily removed from the base simply by lifting the barrel portion upward using the handles on the sidewalls of the barrel. This quick and easy disassembly allows the user to add fuel and/or clean out ash or drippings easily. The base can be easily lifted by the user, allowing the user to simply dump the ash and drippings in an appropriate receptacle. Of course, in some embodiments, the barrel cooker may include one or more latches or other securing mechanisms for securing the barrel portion to the separate base to prevent disassembly of the barrel and base in the case of moving the barrel cooker, or a tip-over or other accident.

The separate base may include a centrally positioned air intake that may be positioned concentrically with the vertical axis of the vertical barrel cooker and is operable to direct the flow of air to the perimeter of the barrel in a uniform manner to promote a circulating and even airflow. The air intake may include at least one central intake vent. In some embodiments, the central intake vent may include a single central hole in the bottom surface of the separate base. In various embodiments, and without limitation, the central hole may have an area in a range of about 3 in.² to about 30 in.² (e.g., about 7 in.² to about 20 in.², or any other value or range of values therein). The central hole may have a shape that is circular, elliptical, polygonal (e.g., triangular, rectangular, pentagonal, other regular polygonal shapes, or irregular polygonal shapes), or some other shape having an isoperimetric quotient of about 0.7 or greater.

In other embodiments, the central intake vent may include two or more holes arranged in a pattern that has a geometric center that is aligned with the central vertical axis of the barrel. The holes may have various shapes, such as slots of varying length and width; a concentric circular pattern of slots, which may include circular deflectors or baffles that sit over each slot and deflect the incoming air to the periphery of the barrel; a polygonal tessellation-like pattern (e.g., with triangles, squares, hexagons, or combinations of polygonal shapes, such as pentagons and hexagons, etc.), concentric circular pattern of slots (e.g., multiple slots each forming near complete circles arranged in a circular pattern having a center point aligned with the central vertical axis of the barrel), or other appropriate arrangements. By way of example and without limitation, the two or more holes in the central air intake may have a total area in a range of about 3 in.² to about 30 in.² (e.g., about 7 in.² to about 20 in.², or any other value or range of values therein).

In embodiments having a central air intake, the intake (in combination with the damper, as discussed below) may be calibrated to allow an appropriate volume of O₂ gas into the base to support a consistent interior convectional heat flow that maintains a temperature in a pre-determined narrow range (e.g., a range that varies by about 40° F. or less, such as, without limitation, about 275° F. to about 300° F.). Additionally, the size and pattern of the air intake hole(s) or slots may be precisely sized relative to the volume of the cooking vessel to facilitate the precise control of the temperature range during cooking.

In embodiments having a central air intake, the intake may further include a circumferential wall or lip that encircles the air intake and prevents ash from falling out of the bottom of the cooker. The circumferential wall or lip may be of sufficient height to retain a substantial amount of ash in the base, without any significant obstruction of air flow through the central air intake. The circumferential wall around the opening in conjunction with the outer cylindrical wall of the base forms a basin which collects ash and drippings, preventing ash from exiting through the opening and making the drippings available for evaporation to provide moisture inside the cooker. By way of example and without limitation, embodiments of the circumferential wall may have a height in a range of about ⅛ in. to about 1 in. (e.g., any other value or range of values therein).

In most embodiments of the invention, a diffuser is provided above the centrally positioned air intake in the base. The diffuser preferably has a dome or convex shape, but in other embodiments it may have a flat or concave shape. The diffuser is positioned over the air intake opening in the base, leaving a gap between the diffuser and the opening to allow air to flow into the cooker. The diffuser may be concentric with the centrally positioned air intake. The diffuser may have a sufficient diameter to completely cover the central air intake so as to prevent ash and drippings from falling through and/or clogging up the central air intake, while also allowing air to enter through the opening.

In alternative embodiments, the diffuser may have a pan-like structure, forming a small basin for collecting drippings and ash, but preventing them from exiting through the lower vent opening. In other examples, the diffuser may have other pan-like shapes. In some examples, the diffuser may have a shallow cone structure. Other appropriate shapes for the catch are contemplated within the scope of the invention, as well.

The diffuser may be suspended above the central air intake, providing a gap for air flow between the catch and the circumferential wall of the air intake. The diffuser may be connected to the circumferential wall or the floor of the separate base by one or more vertical brackets or other supports. For example, and without limitation, a convex diffuser may be positioned above the central air intake or the circumferential wall around the central intake (if present) at a distance in a range of about ¼ inch to about 4 inches (e.g., about 1 inch to about 2.5 inches, or any other value or range of values therein). The diffuser may be positioned at a calibrated predetermined distance above the central air intake to provide a predetermined air flow into the barrel.

The convexity of the convex diffuser may protrude upward into the barrel such that it deflects the drippings from the food being cooked. For example, in some embodiments the convex diffuser may have a dome or spherical cap shape. In other embodiments, the convex diffuser may have other convex shapes having sufficient diameter to cover the central air intake, such as a shallow cone, a shallow pyramid, an ellipsoidal cap, and other appropriate convex shapes.

Three or more support structures (e.g., legs) may be positioned on the bottom side of the separate base at or near the perimeter of the base. The support structures may be distributed along the perimeter of the base such that they are able to stably support the weight of the barrel cooker (e.g., the support structures may be positioned at uniform intervals along the perimeter). In other embodiments, the barrel cooker may include a base stand that engages with bottom side of the separate base and lifts the system off of the ground. The support structures or base stand allow air to flow underneath the base itself and thereby enter the cooker through the lower vent opening therein. These supports also prevent contact or close proximity of the barrel cooker with ground or surface on which the barrel cooker rests, to thereby allow heat radiated from the bottom of the barrel cooker to dissipate before it reaches the surface on which the system is positioned. As a result, discoloration or other damage to the surface (e.g., concrete, tile, decking material, etc.) can be prevented. The base stand includes one or more openings therein to allow airflow under the system.

Embodiments of the invention may include a heat source that provides heat for cooking meats and other foods placed in the barrel cooker. The fuel for the heat source may use a solid fuel (e.g., a charcoal, wood, or fuel pellet basket). The heat source may be contained within a cylindrical housing that may help to direct the heat produced by the burning fuel vertically toward the food items, and help to prevent the loss of heat to the sidewall of the barrel. There may be a gap between the cylindrical housing of the heat source and the wall of the barrel structure to both further isolate the heat source from the outer wall of the barrel structure, and to provide a route for airflow between the heat source and the outer wall of the barrel structure. The gap may aid in generating convectional and even heating through the column of the barrel structure.

The heat source may be a coal basket having a pre-determined volume for holding a predetermined amount of fuel (e.g., charcoal). The coal basket may include an outer wall that rests on the floor of the separate base, and a grill or grate therein for supporting a solid fuel placed therein and supported by the outer wall. The outer wall of the coal basket wall may have one of several shapes including a circle, an ellipsoid, a polygonal shape, such as a triangle, rectangle, pentagonal, etc. The grate may have a shape that corresponds to the outer wall such that it nests therein without significant gaps.

The amount of the fuel (e.g., charcoal) held by the coal basket may be calibrated to provide a consistent heat and temperature range in the interior of the cooking system during use. The coal basket may have multiple volume options for adding fuel. More specifically, the coal basket may have multiple, discrete configurations that provide specific basket volumes that each allow the user to measure out a specific volume of solid fuel for cooking. In some implementations, and without limitation, a grate may be fixedly positioned within the cylindrical housing of the coal basket such that two different predetermined volume options are provided: the user can simply flip the coal basket over to switch between two volume options. Other coal basket structures are also contemplated within the scope of the present invention. For example, and without limitation, the coal basket may include an adjustable coal grate that can be moved to one of several alternative positions within the outer wall of the coal basket. For example, pegs, lips, or other support structures may be provided at intervals within the cylinder of the coal basket to allow the user to move the grate between several discrete levels within the coal basket.

In embodiments of the invention, the outer wall of the coal basket may be positioned on the surface of the separate base and the grate of the coal basket may be centered above the diffuser. The grate may have sufficient clearance over the (e.g. convex) diffuser to allow for a gap between the grate and the convex diffuser of about 1 inch to about 5 inches (e.g., in a range of about 2 inches to about 4 inches, or any value or range of values therein). The position of the convex diffuser below the grate allows the convex diffuser to deflect both ash and drippings falling from the fuel and food above, preventing them falling through or clogging up the central air intake.

In some embodiments, and without limitation, the barrel may include a coal basket support assembly that allows the coal basket to be positioned at higher positions in the barrel to allow the coal basket to supply heat in closer proximity to the food to be cooked. The coal basket support assembly may be positioned at one or more positions in the column of the barrel (e.g., at mid barrel), at one or more positions in a range of about 1 to about 3 feet above the convex diffuser. For example, an internal support structure for a grill or other vented platform operable to support the coal basket may be included to allow the coal basket to be positioned at one or more additional positions in the barrel. For example, pegs, lips, internally projecting beads, or other support structures may be provided at intervals within the barrel to allow the user to move a grate or other vented platform to one of several discrete levels within the barrel, after which the coal basket is placed thereon.

In further embodiments, and without limitation, the heat source of the outdoor cooking system may be a round burner structure centered within the base of the barrel structure that provides an even heat column through the barrel structure. The burner may be fueled with a gas fuel source such as propane, natural gas, etc. deployed over or around the diffuser. In still further embodiments, the heat source may be an electric heating element deployed over or around the diffuser.

In some embodiments, the cooking systems of the present invention may include a heat shield that is positioned between the sidewall of the barrel and the heat source. The heat shield may be a cylindrical or substantially cylindrical structure having a diameter that is slightly less than the inner diameter of the sidewall of the barrel, such that it sits close to the interior of the sidewall of the barrel. The vertical height of the heat shield may overlap all of the heat source and extend vertically beyond the top of the heat source, such that the heat generated by the heat source is substantially retained within the cooking system. The heat shield may be made from a heat resistant and/or reflective material that prevents or reduces the transfer of heat from the interior of the barrel cooker.

Embodiments of the invention may include one or more specialized dampers for regulating the airflow through each air intake in the separate base. Each damper may be an adjustable mechanism operable to cover an air intake to varying extents, allowing the user to adjust the amount of air flowing through the air intake. Each damper may be operable to adjust the area of an air intake with continuous discrete settings between 0% and 100% of the area of the air intake vent.

In some embodiments having a central intake opening, the damper may be a slidable plate having a damper hole therein that has the same or substantially the same diameter as the central air intake vent. In embodiments of the invention, the damper may be coupled to the bottom of the separate base by a track in which the slidable plate nests, where the slidable plate is guided along the track as the user moves the slidable plate. The track aligns the slidable plate with the air intake hole(s) and guides the slidable plate to be slidable in a radial manner with respect to the base, allowing the user to pull out and push in the slidable plate along a radial path to adjust the portion of the central air intake exposed by the damper. The centers of the central air intake vent and the damper hole may be aligned along the sliding path of the damper plate to allow full exposure of the central air intake, or they may be offset to partially restrict air intake.

In embodiments of the invention, the damper may have a handle that protrudes laterally from the bottom of the barrel cooker to allow the user easy access to adjust the position of the damper and the proportion of the air intake vent occluded by the damper plate. The handle of the damper may have markings thereon to indicate the position of the hole in the damper plate relative to the central air intake. For example, the handle may include markings on the handle that indicate the fraction or percentage (e.g., a range of 1/10 to 1/1, a range of 0% to 100%, etc.) of the central air intake that remains open as the damper handle is pushed toward or pulled away from the barrel cooker, where the proportion of the air intake that is occluded is indicated by the number marking that is visible immediately adjacent to the outer perimeter of the barrel cooker.

In some embodiments, the damper may have discrete settings that expose a pre-determined portion of the central air intake for progressive altitude ranges to ensure consistent cook temperatures for at various altitudes, thereby eliminating or reducing fire management requirements. By way of example and without limitation, the damper may have four discrete settings indicated by markings on the handle of the damper. The four discrete settings may be for, e.g., from about sea level to about 1000 ft above sea level, from about 1000 ft above sea level to about 2500 ft above sea level, from about 2500 to about 4000 ft above sea level, and for about 4000 ft above sea level and higher, respectively.

In other embodiments, the damper may have a rotating damper plate that is parallel to the horizontal plane of the central air intake. In such embodiments, the damper may rotate in a horizontal plane around an axis (e.g., held in place by a rotating joint with the separate base) as the user pulls (slides) the handle of the damper along the perimeter of the barrel cooker. The perimeter of the separate base may be marked with indicators for the discrete damper settings, which expose a pre-determined portion of the central air intake for progressive altitude ranges. In still further embodiments, the damper may be a butterfly style damper system, a ball valve, or gate valve style control. It is to be appreciated that in other embodiments, the damper may have more or less than four prescribed settings as long as higher altitude increments allow a greater amount of airflow into the cooking chamber. It is also to be appreciated that in embodiments where multiple vent openings are provided in the separate base, each such opening may be provided with any of the damper structures described herein.

During operation of an exemplary cooking system having a single central lower air intake opening and a convex diffuser, the central air intake provides the sole source of air. Air may enter the system through the air intake at the base of the system according to the damper setting, and then be deflected outward from center by the convex diffuser, such that a broad column of air rises through the coal basket (e.g., a column having a diameter in the range of about 10 inches to about 20 inches, depending on the diameter of the central air intake and convex diffuser). Without the convex diffuser over the central air intake, the air would not be displaced evenly and a chimney-effect would result, causing the coals to burn unevenly.

In this exemplary embodiment, the broadened column of air flows through the coal basket, where it is heated, and then flows up through the center of the barrel to provide a wider, even delivery of heat to the food positioned inside the barrel. Once the heated air, smoke, and moisture rises and meets the underside of the lid at the top of the barrel, the air, heat, moisture and smoke are deflected laterally toward the perimeter of the barrel, and then travel downward and adjacent to the heat column rising from the burning fuel.

The hot air column rising through the center of the barrel in this example envelopes the hanging meat or the items placed on grates or hangers in the cooking system. The air column then reaches the inner side of a barrel lid that encloses and seals the upper end of the system, thereby preventing the rising air and heat from escaping. The heated air then is deflected outward from center toward the perimeter of the barrel and downward into the barrel in an inversion effect that results in a circulated flow within the barrel. This circulating flow of air and heat provides a uniform heating zone precisely where the cooking items are placed. Eventually the air does find its way out one or more small exhaust holes around the exterior perimeter of the barrel near the top of the barrel. In alternative examples, the exhaust holes may be provided in the lid or other portions of the cooking system. For example, the lid may include a plurality of holes with an adjustable cover or damper to control the amount of heated air and smoke that is allowed to escape from the barrel.

It has been found that this cooking method produces a constant and narrow internal temperature range of about 275° F. to about 300° F. (e.g., 275° F. to about 300° F.), which provides consistent, predictable cooking results. The damper may be used for incremental altitude settings denoted on the damper handle or elsewhere to achieve and sustain the internal temperature range of 275° F. to about 300° F. until the fuel source is exhausted. Additional air flow control is provided beyond these incremental or target temperature ranges to allow for cooking temperatures in excess of 500° F., if desired, to facilitate alterative cooking methods.

The position of the heat source, the centralized air intake, the deflection of air entering the barrel to broaden the rising column of air in the barrel, the controlled airflow from beneath the heat source, and the controlled outflow of air, smoke, and moisture from the system collectively serve to generate a convection flow of heat from the heat source up through the center of the barrel structure up to the closed top of the system and then down along the perimeter of the system. The convectional heat flow provides energy efficiency in the cooking process, even cooking, and a controlled central air column that aids in reducing the exterior temperature of the system, reducing the potential for heat injuries to the user. Also, the size of the central air intake, the predetermined distance of the diffuser above the air intake, a predetermined coal basket volume, and the exhaust holes (e.g., four exhaust holes near the upper end of the chamber, as described in one embodiment herein), which are calibrated to the specific chamber volume, result in a prescribed burn rate and targeted cooking chamber temperature, which allows for a predictable cooking time for various foods.

Embodiments of the invention described herein more accurately control the burn rate and thus the temperature of the cooker in a manner that reduces the time and expertise required to properly cook various meats and other foods, providing increased cooking efficiency, while reducing the effort required by the user.

It is an object of the present invention to provide an outdoor cooking system that provides for even, consistent cooking temperature that allows the user to prepare meats and other foods with a consistent cook time and reliable cooking results.

It is also an object of the invention to provide an outdoor cooking system that efficiently utilizes airflow from below the heat source up through the center of the column of the barrel-like system and then back down around the perimeter of the interior of the barrel-like structure to create convection flow heating that provides an even temperature profile in the interior of the system.

It is a further object of the present invention to provide an outdoor cooking system that has a precisely controlled air flow system that maintains a consistent level of moisture and aids in maintaining a consistent temperature and cooking time.

It is a further object of the present invention to provide an outdoor cooking system that provides predictable and consistent cooking for various food items. Cook times for the various food items can vary and the cook time may be controlled with the volume of fuel provided in the fuel basket.

It is a further object of the present invention to provide an outdoor cooking system having a separate base that allows the user easier access to the heat source to fill, prepare, and light the heat source, and to empty ash from the system.

It is a further object of the invention to provide an outdoor cooking system that reduces the heat on the exterior of the system, while retaining heat and energy within the system for efficient cooking of food items therein.

It is a further object of the present invention to provide a versatile outdoor cooking system that includes multiple adjustable grill racks that can be vertically repositioned within the system.

It is a further object of the present invention to provide an outdoor cooking system that includes a modular cooking rack system that can be positioned on multiple horizontal planes simultaneously.

It is a further object of the present invention to provide an outdoor cooking system that includes a premeasured fuel basket that has multiple fuel volume options that can be selected based on the appropriate cooking duration for the food items to be cooked.

It is a further object of the present invention to provide an outdoor cooking system that includes an adjustable vent in the bottom of the system for changing the airflow to vary the cooking temperature inside the system.

It is a further object of the present invention to provide an outdoor cooking system that includes an adjustable vent in the bottom of the system with a diffuser cap above the vent that not only disperses air flow to the perimeter of the coal basket for a more even coal burn and consistent cooking chamber temperature, but also directs ash and drippings from the food being cooked away from the opening.

It is a further object of the present invention to provide an outdoor cooking system that includes an adjustable vent opening in the bottom of the system with a diffuser cap above the vent that prevents the vent opening from being clogged, and makes food drippings available for evaporation to provide moisture inside the cooker.

### BRIEF DESCRIPTION OF THE DRAWINGS

FIG. 1 is a front perspective view of an embodiment of a barrel cooker of the present invention.

FIG. 2A is a perspective view of an embodiment of a base for a barrel cooker of the present invention.

FIG. 2B is a perspective view of an alternate embodiment of a base for a barrel cooker of the present invention.

FIG. 3 is a bottom perspective view of a barrel portion of an embodiment of a cooker of the present invention.

FIG. 4 is a portion of a sectional side view of an embodiment of the present invention showing a barrel portion engaged with a base portion.

FIG. 5 is a bottom plan view of an embodiment of a base of the present invention.

FIG. 6A is a perspective view of an embodiment of a base for a barrel cooker of the present invention supporting an embodiment of a coal basket.

FIG. 6B is a perspective view of an alternate embodiment of a base for a barrel cooker of the present invention supporting an embodiment of a coal basket.

FIG. 7 is a partially cut-away side view of an embodiment of a cooker of the present invention showing interior features.

FIG. 8 includes several perspective views of embodiments of accessories for a cooker of the present invention, including some uses thereof.

FIG. 9 includes several perspective views of embodiments of a barrel portion of the present invention showing different configurations of grills and support structures.

FIG. 10 is a bottom plan view of a barrel portion of an embodiment of the present invention with a grill and handles shown in phantom lines.

FIG. 11A is a front perspective view of an embodiment of a barrel cooker of the present invention showing handles and support legs in phantom lines.

FIG. 11B is a front perspective view of an embodiment of a barrel cooker of the present invention with surface shading and showing handles and support legs in phantom lines.

FIG. 12A is a left side elevational view of an embodiment of a barrel cooker of the present invention showing handles and support legs in phantom lines.

FIG. 12B is a left side elevational view of an embodiment of a barrel cooker of the present invention with surface shading and showing handles and support legs in phantom lines.

FIG. 13A is a right side elevational view of an embodiment of a barrel cooker of the present invention showing handles and support legs in phantom lines.

FIG. 13B is a right side elevational view of an embodiment of a barrel cooker of the present invention with surface shading and showing handles and support legs in phantom lines.

FIG. 14A is a front elevational view of an embodiment of a barrel cooker of the present invention showing handles and support legs in phantom lines.

FIG. 14B is a front elevational view of an embodiment of a barrel cooker of the present invention with surface shading and showing handles and support legs in phantom lines.

FIG. 15A is a rear elevational view of an embodiment of a barrel cooker of the present invention showing handles and support legs in phantom lines.

FIG. 15B is a rear elevational view of an embodiment of a barrel cooker of the present invention with surface shading and showing handles and support legs in phantom lines.

FIG. 16A is a top plan view of an embodiment of a barrel cooker of the present invention showing handles and support legs in phantom lines.

FIG. 16B is a top plan view of an embodiment of a barrel cooker of the present invention with surface shading and showing handles and support legs in phantom lines.

FIG. 17A is a bottom plan view of an embodiment of a barrel cooker of the present invention showing handles and support legs in phantom lines.

FIG. 17B is a bottom plan view of an embodiment of a barrel cooker of the present invention with surface shading and showing handles and support legs in phantom lines.

FIG. 18 is a front perspective exploded view of an embodiment of a barrel cooker of the present invention showing separation between the barrel portion and the base, with surface shading and no coal basket.

FIG. 19 is a top plan view of the base of FIG. 18, with surface shading.

FIG. 20 is a front perspective exploded view of an alternative embodiment of a barrel cooker of the present invention showing separation between the barrel portion and the base without coal basket.

FIG. 21 is a top plan view of the base of FIG. 20.

FIG. 22 is a left side elevational view of an embodiment of a base of the present invention with surface shading and showing the legs in phantom lines.

FIG. 23 is a right side elevational view of the embodiment of FIG. 22 with surface shading and showing the legs in phantom lines.

FIG. 24 is a rear elevational view of the embodiment of FIG. 22 with surface shading and showing the legs in phantom lines.

FIG. 25 is a front elevational view of the embodiment of FIG. 22 with surface shading and showing the legs in phantom lines.

FIG. 26 is a bottom plan view of a barrel portion of an embodiment of the present invention with surface shading, and showing a grill and handles in phantom lines.

### DETAILED DESCRIPTION

Various elements of the outdoor cooking systems of the present invention are described below with reference to the drawings submitted herewith. It is to be understood that the embodiments of the present invention may vary in the particular arrangement of one or more of the elements described herein.

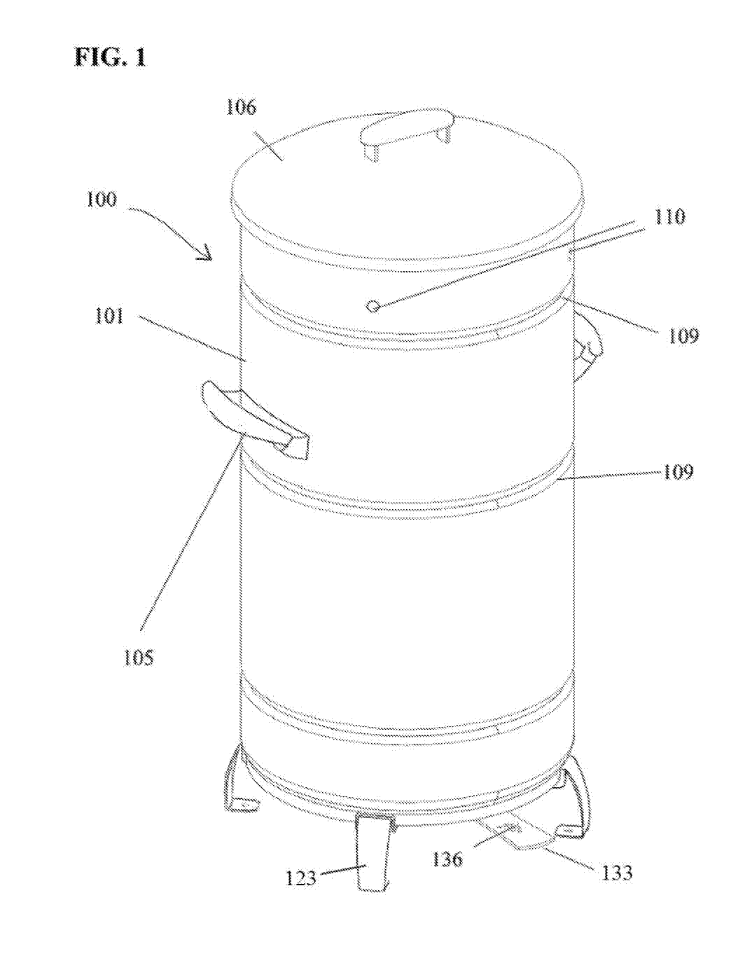

In some embodiments, the present invention may be drawn to a cooker 100 that may include a vessel 101 in the shape of a drum or barrel in which the food items may be suspended and cooked during operation of the cooking system. See FIG. 1. In barrel-shaped embodiments, the vessel 101 may be a barrel-like chassis sub-assembly having multiple accessory beads (annular concave intrusions into the vessel) at various positions in the vessel that allow cooking grates and other structures to be supported within the vessel. It is to be understood that the present invention is not limited to a round barrel-shaped body. For example, and without limitation, other embodiments of the vessel 101 of the invention may include a chassis sub-assembly that may have an elliptical cross-section, a squircle (rounded rectangular) cross-section, and other appropriate shapes. The vessel 101 may include exhaust holes 110, sometimes referred to as ports or vents, located in an upper region of the vessel below the upper end thereof for allowing a controlled amount of air, heat, smoke, and moisture to escape the vessel 101. The exhaust ports may be located on or about the same cross-sectional plane.

The vessel 101 may also be equipped with heat resistant handles 105 to allow the user to lift and move the barrel without risk of burn. The vessel 101 may further include a lid 106 that may be closed over the upper end of the vessel 101 to provide a tight seal to prevent the loss of air, heat, moisture, or smoke from the top of the cooker. The lid 106 may be convex in shape, and may have sufficient weight to prevent hot air, moisture, or smoke from escaping. A heat insulating gasket may be present on the outer perimeter of the lid 106 where the lid contacts the upper edge or rim of the vessel body, and may help to seal the system and retain air, heat, moisture, and smoke in the system.

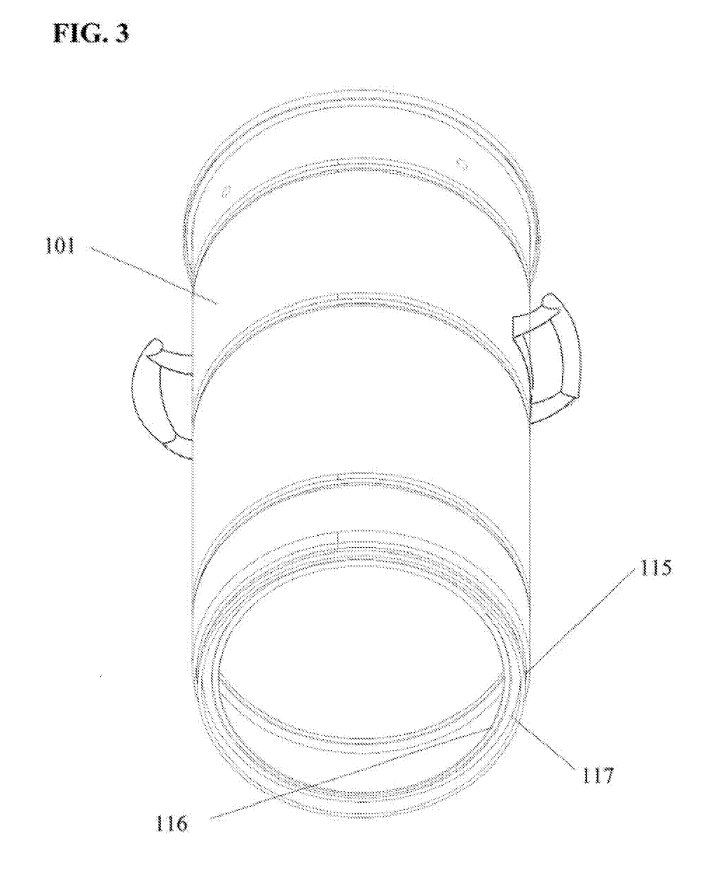

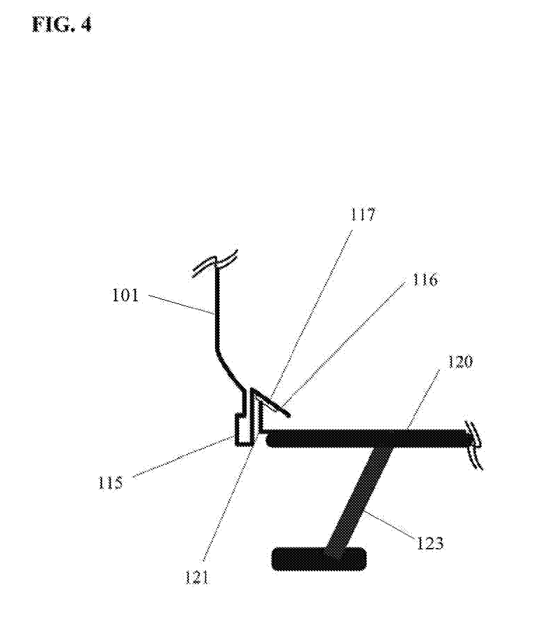

The vessel 101 may sit atop a separate base sub-assembly 120 when the cooker 100 is fully assembled. The vessel 101 may simply sit on top of the outer wall 121 of the base sub-assembly 120. The vessel 101 may include a lip or protrusion 115 at its lower perimeter that may serve to overlap with the outer wall 121 of the base sub-assembly 120, to provide a nested fit between the two sub-assemblies. As shown in FIGS. 3-4, the vessel 101 may also include sloped peripheral flange (e.g., an annular ring) 116 positioned on the inner side of the lip 115 at the lower end of the sidewall of the vessel 101. By way of example and without limitation, the peripheral flange 116 may be sloped downward relative to the horizontal at an angle in a range of about −10° to about −60° (e.g., about −15° to about −45°, or any value or range of values therein). The vessel 101 may further include a peripheral gasket 117 that is attached to the bottom side of the sloped peripheral flange 116 to provide a contact surface for the outer wall 121 of the separate base assembly 120, and may provide a seal therebetween. The gasket 117 may be a polymeric or composite material having sufficiently high heat resistance to prevent deterioration of the gasket for an extended period of use. For example, the gasket material may be vulcanized rubber, fluoro-silicone rubber, polysiloxane, a composite of polymer (e.g., nitrile, carboxylated nitrile, chloroprene, etc.) and a ceramic (e.g., aluminosilicates, etc.), and other polymer or composite heat-resistant materials.

The lip 115 may have a snug fit over the vertical sidewall 121 of the separate base assembly 120, but the vessel 101 may be quickly and easily removed from the base simply by lifting the vessel 101 upward using the handles 105. This quick and easy disassembly allows the user to add fuel and/or clean out ash or drippings easily.

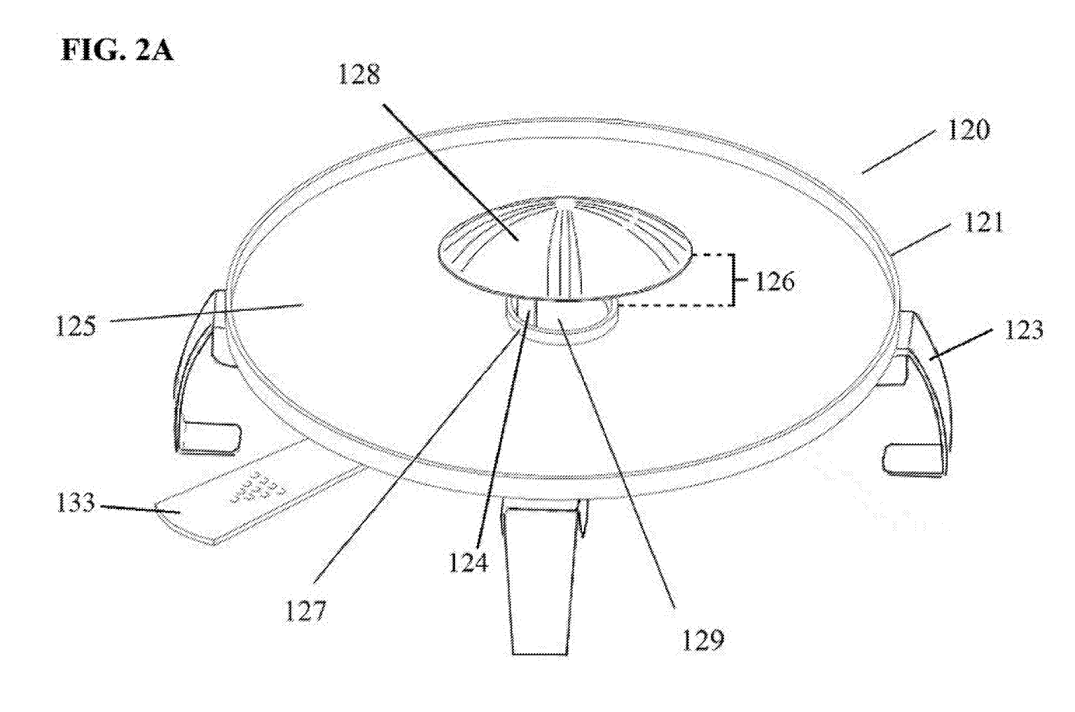

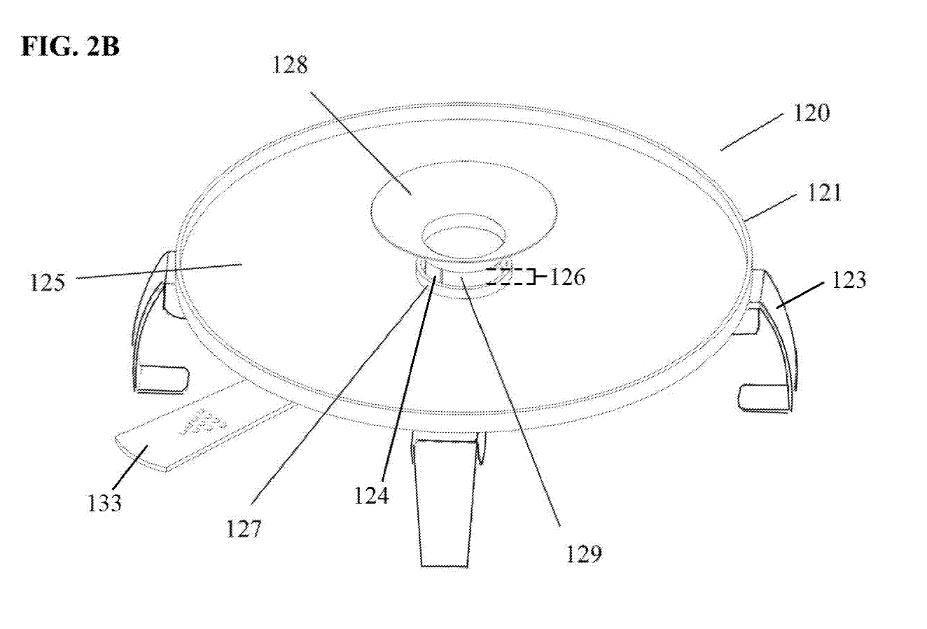

As shown in FIGS. 2A-2B, the separate base may include a plurality of legs 123 and a centrally positioned air intake on a generally horizontal bottom surface thereof that is positioned concentrically with the vertical axis of the vessel 101 and is operable to direct the flow of incoming air outward from center and lateral to the central axis of the vessel 101. The legs 123 provide a space below the air intake to allow air to enter the vessel through the intake, and supply air to the perimeter portions of the fuel basket and provide a wide heat column and circulation within the vessel 101. The air intake may include at least one central intake vent 129. In some embodiments, such as those illustrated in FIGS. 2A-2B, the intake vent 129 may include a single central hole in the generally horizontal surface 125 of the base, the vent having a diameter in the range of about 1 inch to about 6 inches (e.g., about 2-3 inches, or any value or range of values therein). In other embodiments, the intake vent may include two or more holes on surface 125 arranged in a pattern that has a geometric center that is aligned with the central vertical axis of the barrel or vessel, as discussed herein. The air intake may be calibrated to allow an appropriate volume of O₂ (oxygen) gas into the separate base sub-assembly to support a consistent interior convectional heat flow that maintains a temperature in a pre-determined narrow range (e.g., a range that varies by about 40° F. or less, such as, without limitation, about 275° F. to about 300° F.). The central air intake 129 may further include a peripheral wall 127 that encircles the air intake hole 129 and prevents ash and drippings from falling out of the bottom of the cooker. The peripheral wall 127 may be of sufficient height to retain a substantial amount of ash and drippings in the separate base, without any significant obstruction of air flow through the central air intake 129.

Above the centrally positioned air intake, a diffuser 128 may be positioned concentrically with the centrally positioned air intake hole 129. The diffuser 128 preferably has a convex or dome shape as shown in FIG. 2A, but may also have a concave shape as shown in FIG. 2B, or another suitable shape. Diffuser 128 should preferably have a sufficient diameter to completely cover the central hole 129 and prevent ash and drippings from falling through and/or clogging up the central air intake. In the preferred embodiment shown in FIG. 2A, the dome shape of convex diffuser 128 directs ash and drippings away from opening 129 and into a basin on surface 125 formed between walls 127 and 121 of base 120. In the embodiment shown in FIG. 2B, the concave or bowl shape of diffuser 128 collects ash and drippings, and when filled, also directs ash and drippings away from opening 129 and into basin 125. The diffuser 128 may be suspended above the central air intake hole 129, providing a gap 126 for air flow between the diffuser 128 and the circumferential wall 127 of the air intake 129. The diffuser 128 may be connected to the circumferential wall 127 or the floor of the separate base 120 by vertical brackets, legs or other supports 124.

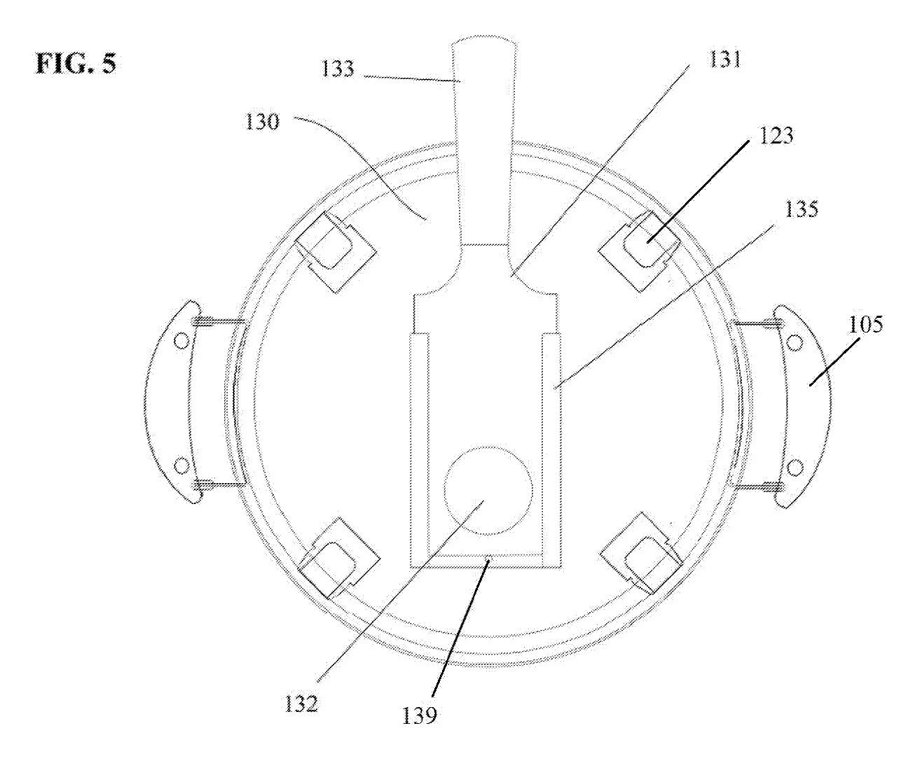

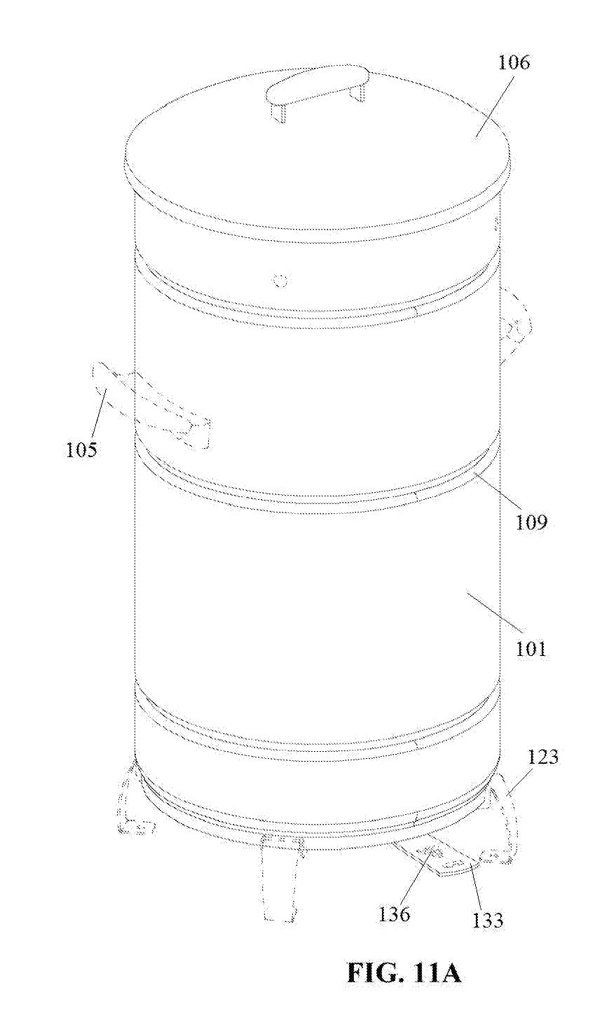

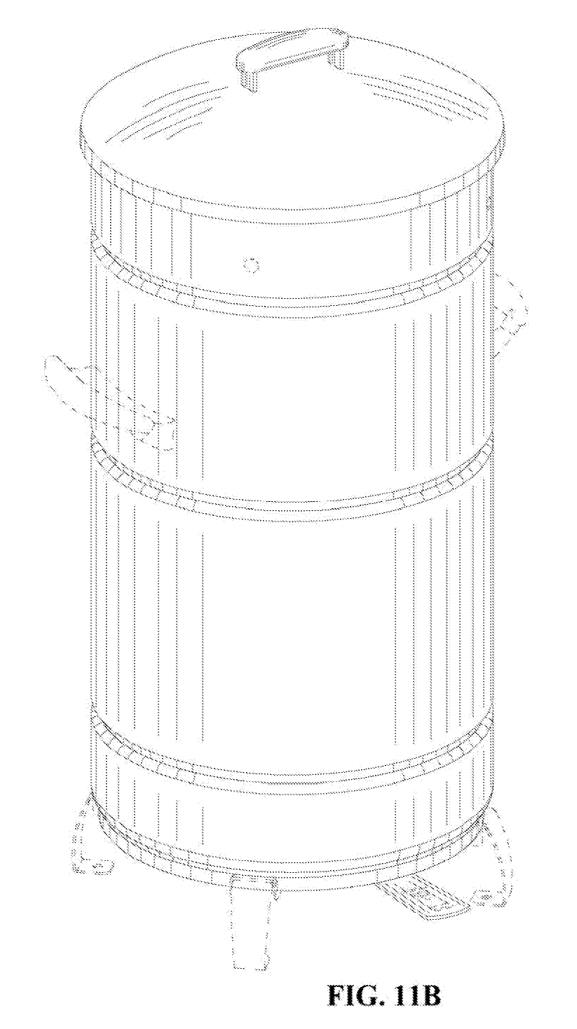

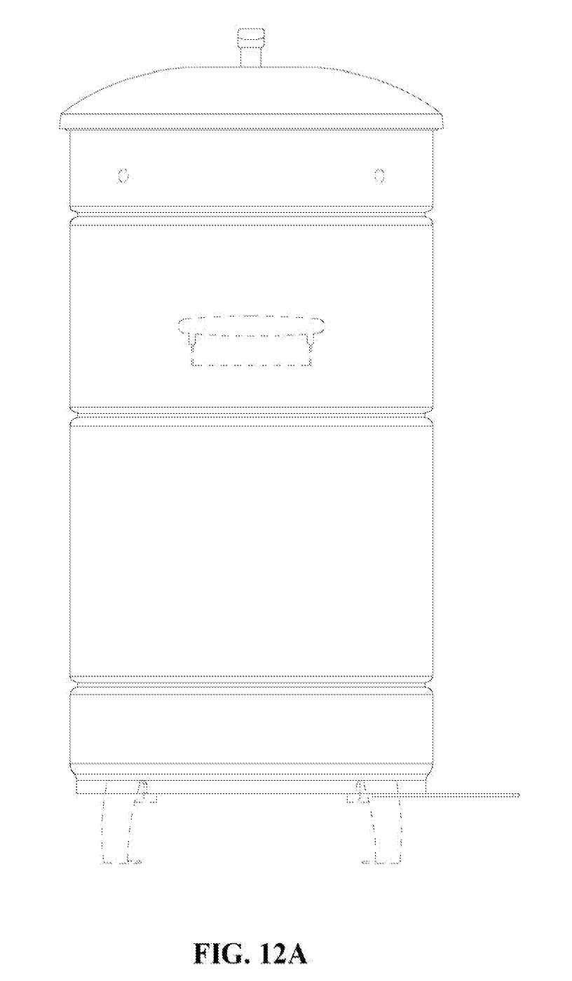

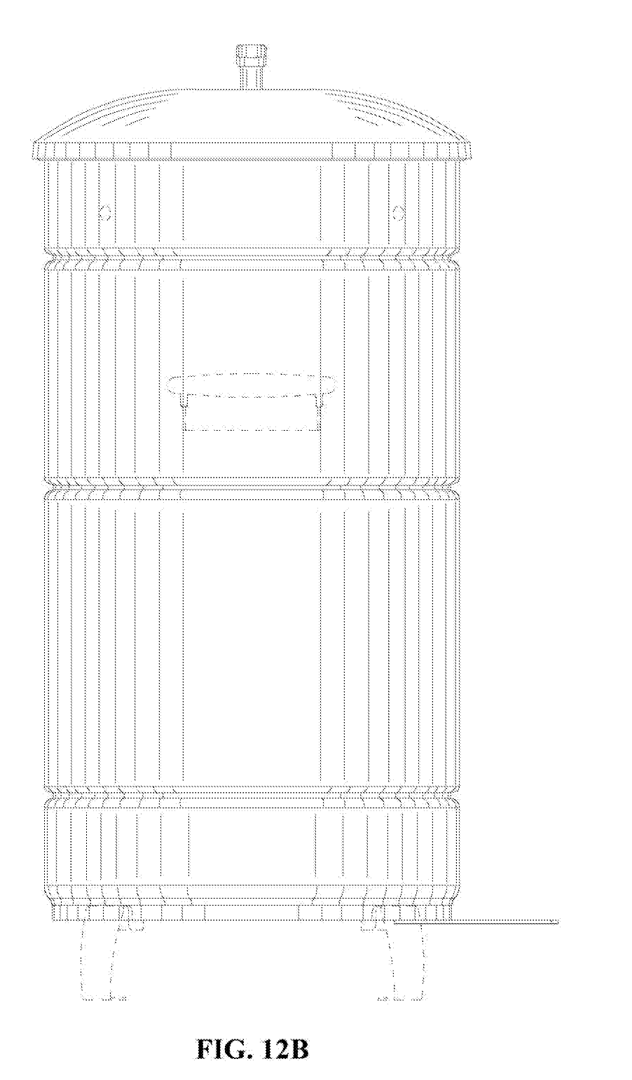

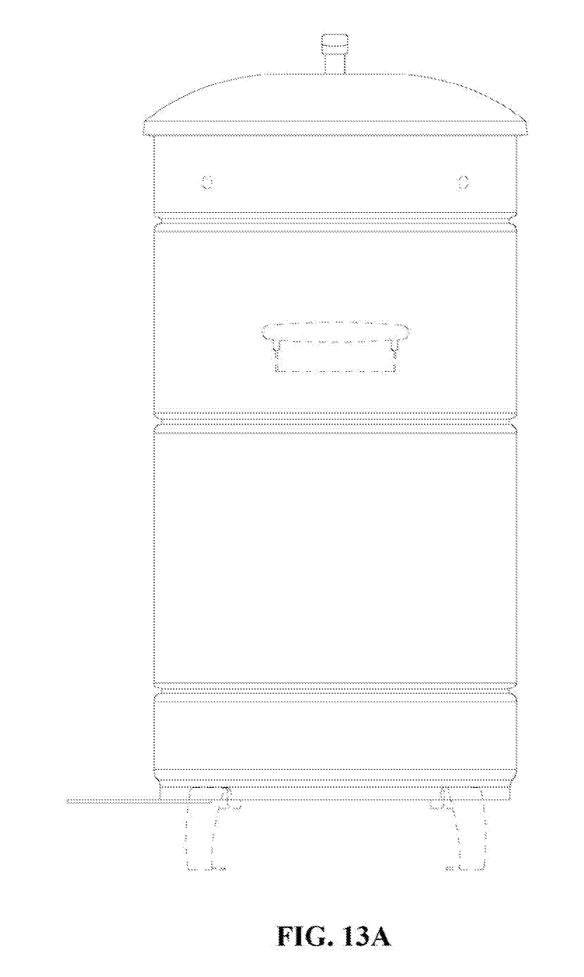

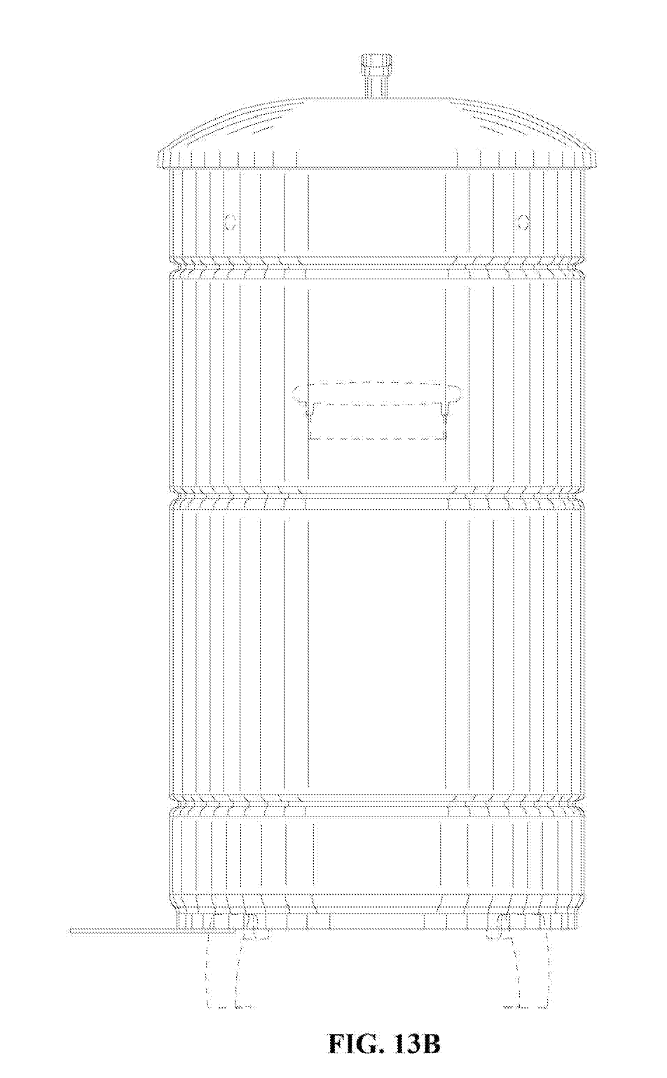

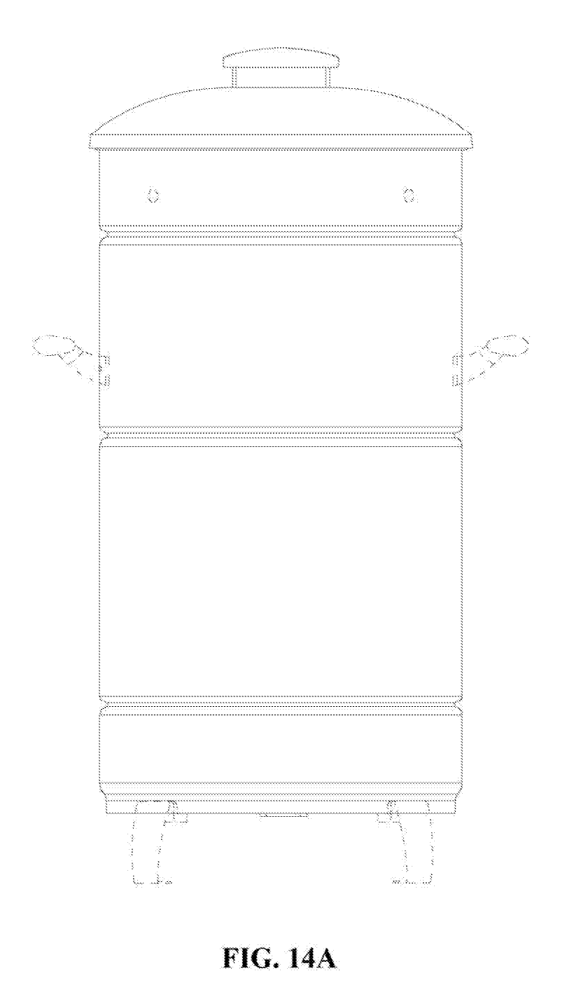

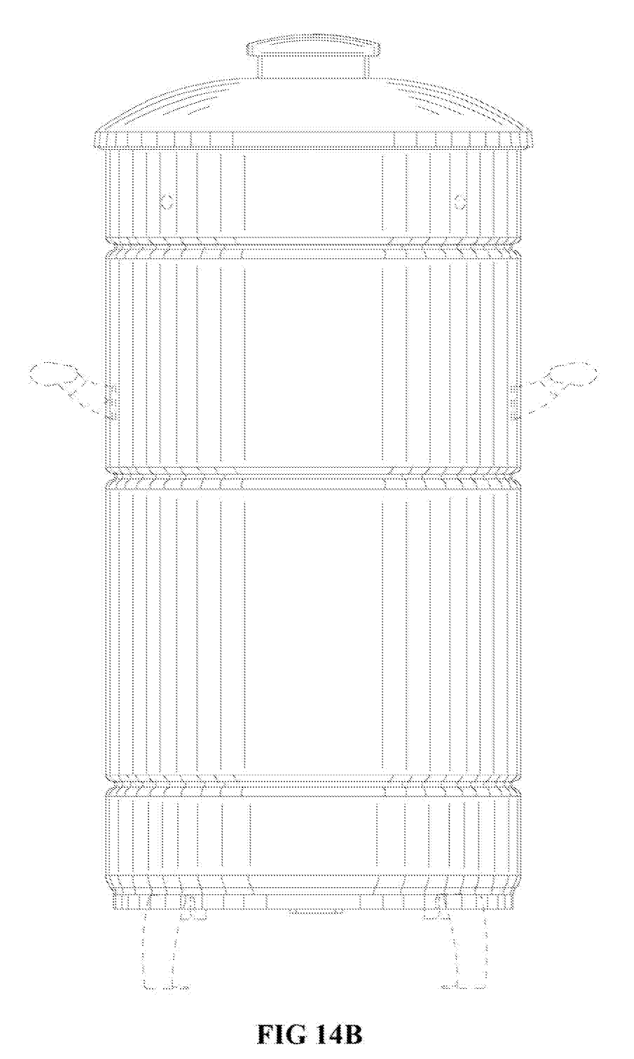

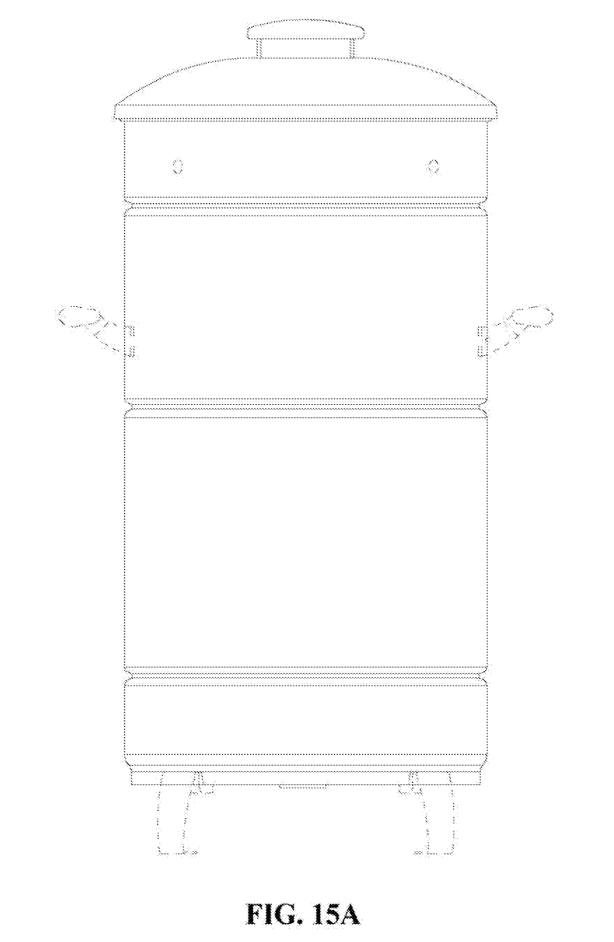

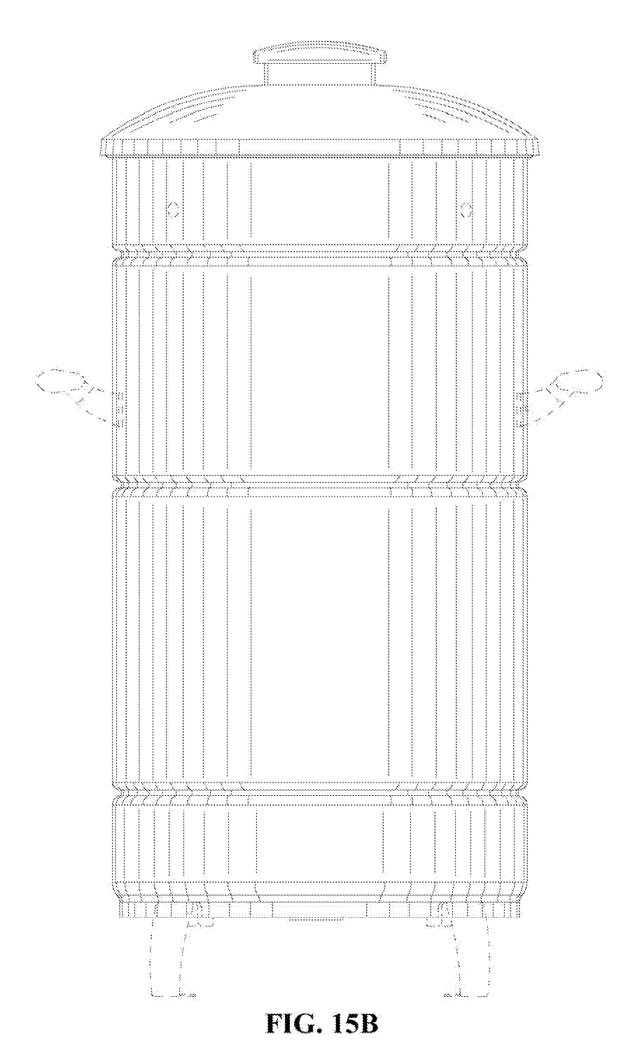

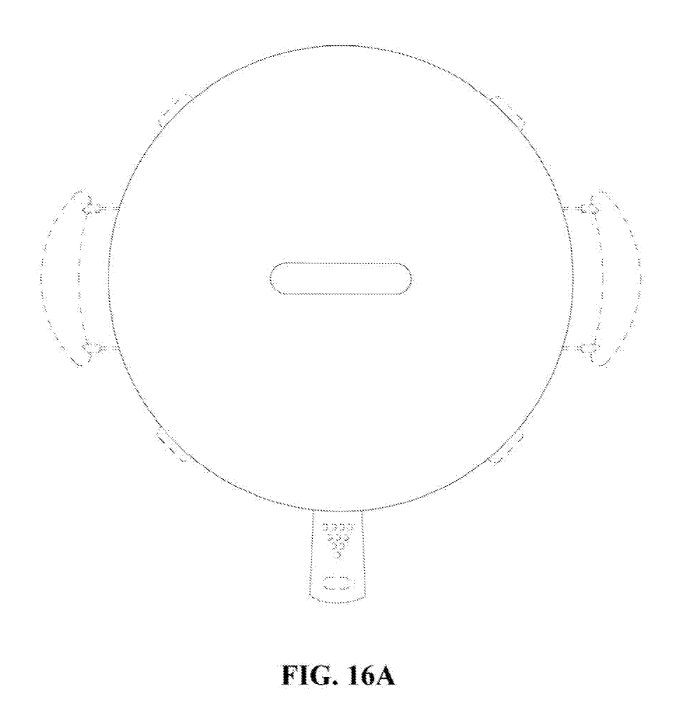

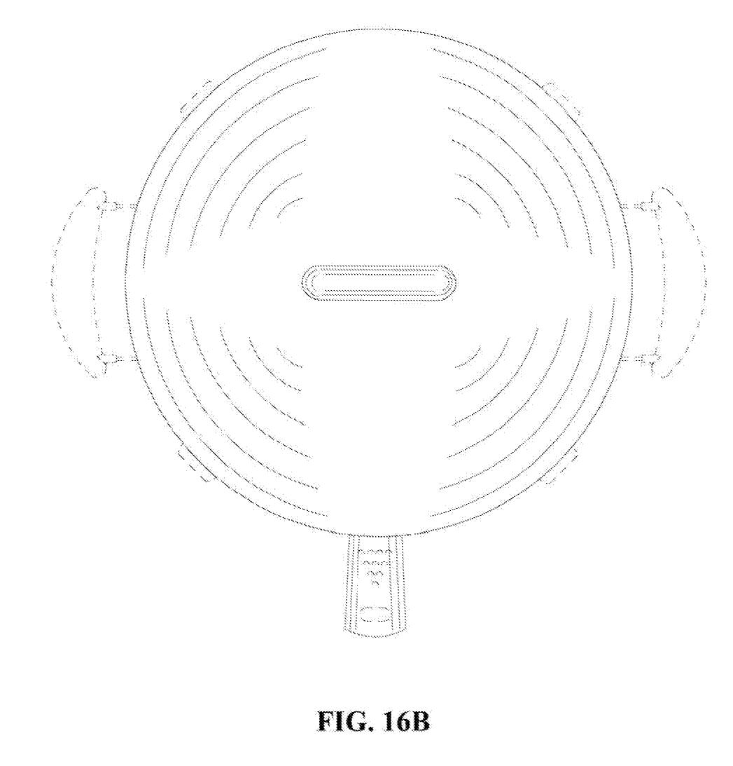

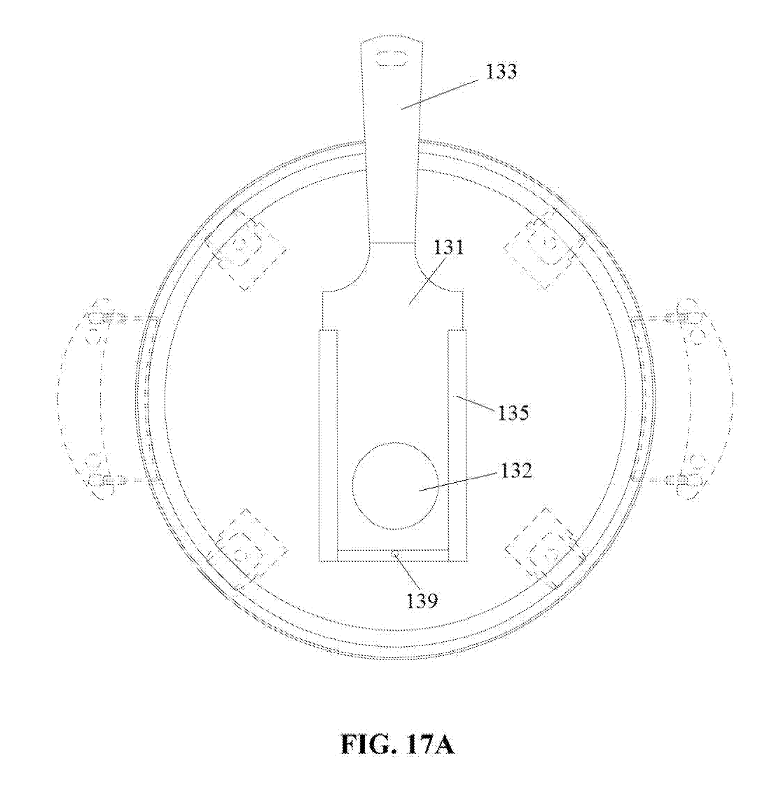

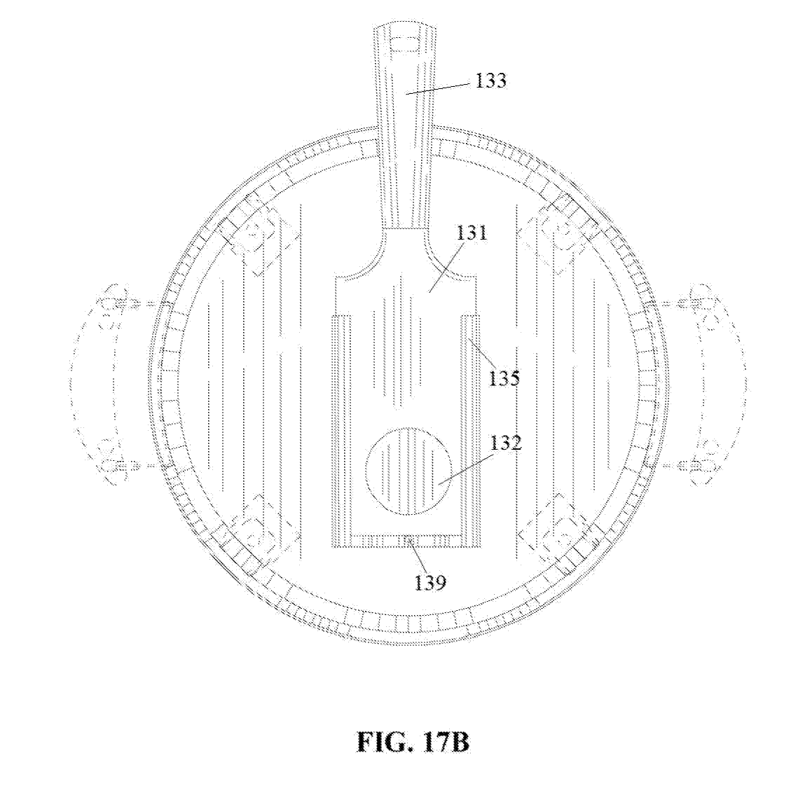

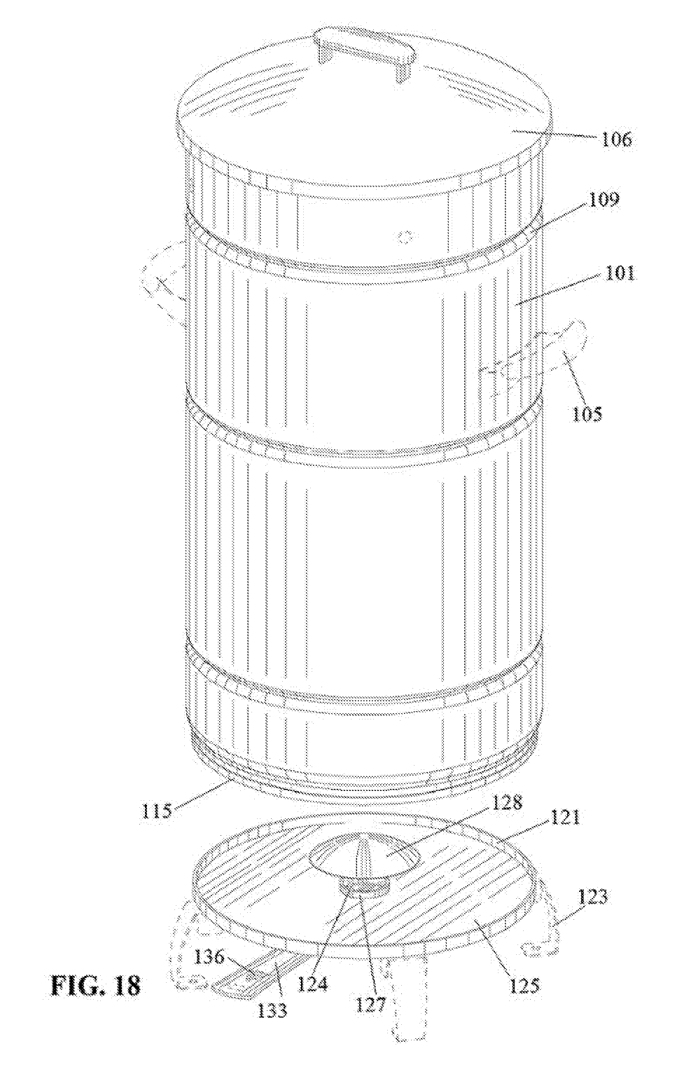

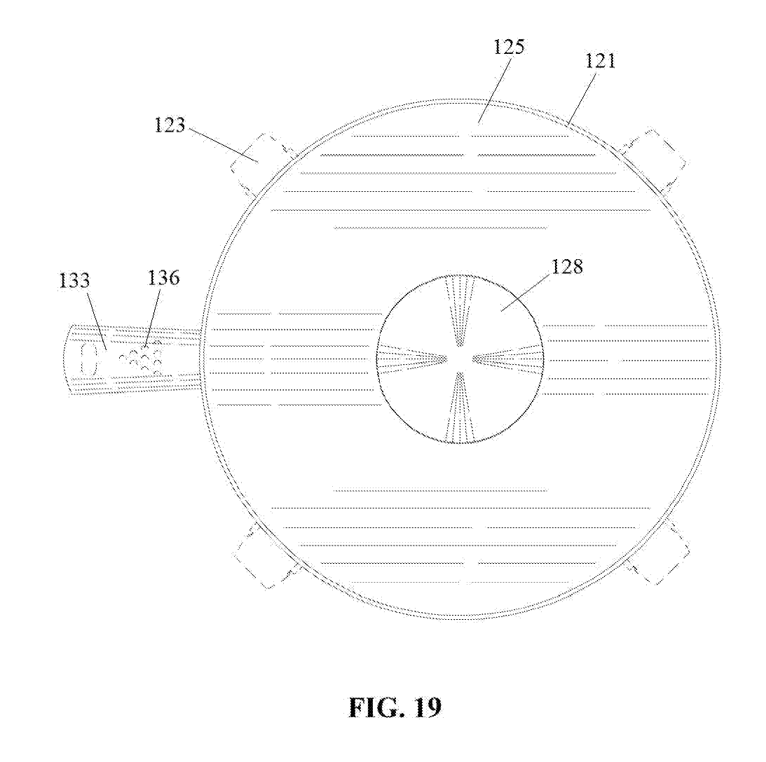

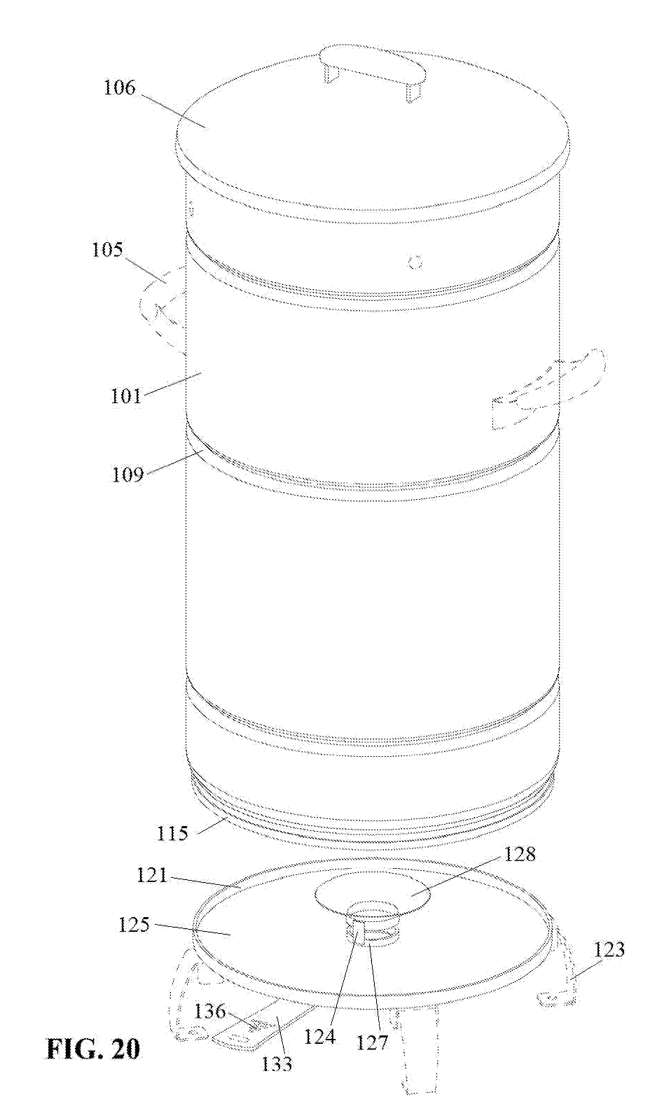

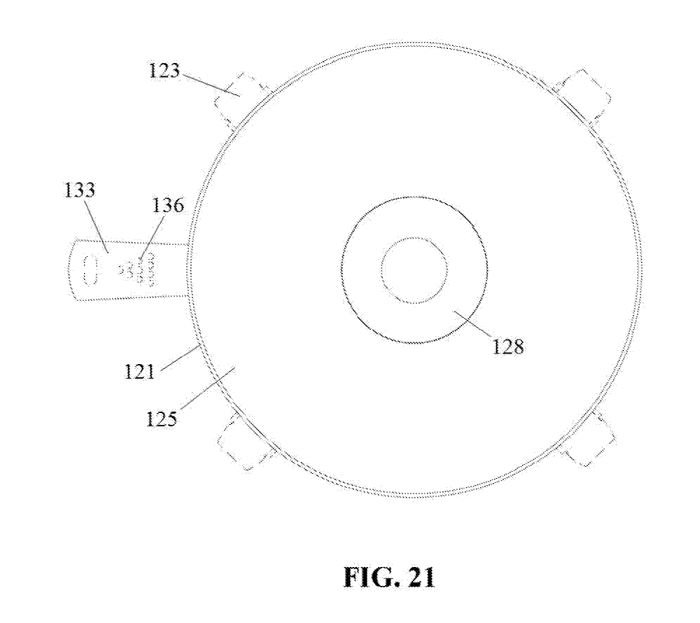

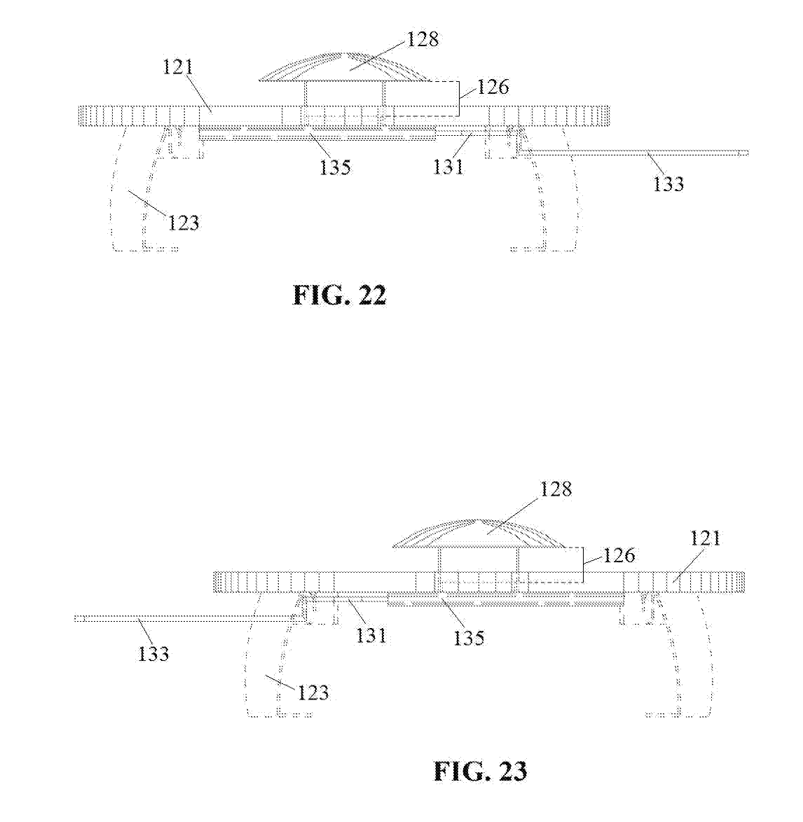

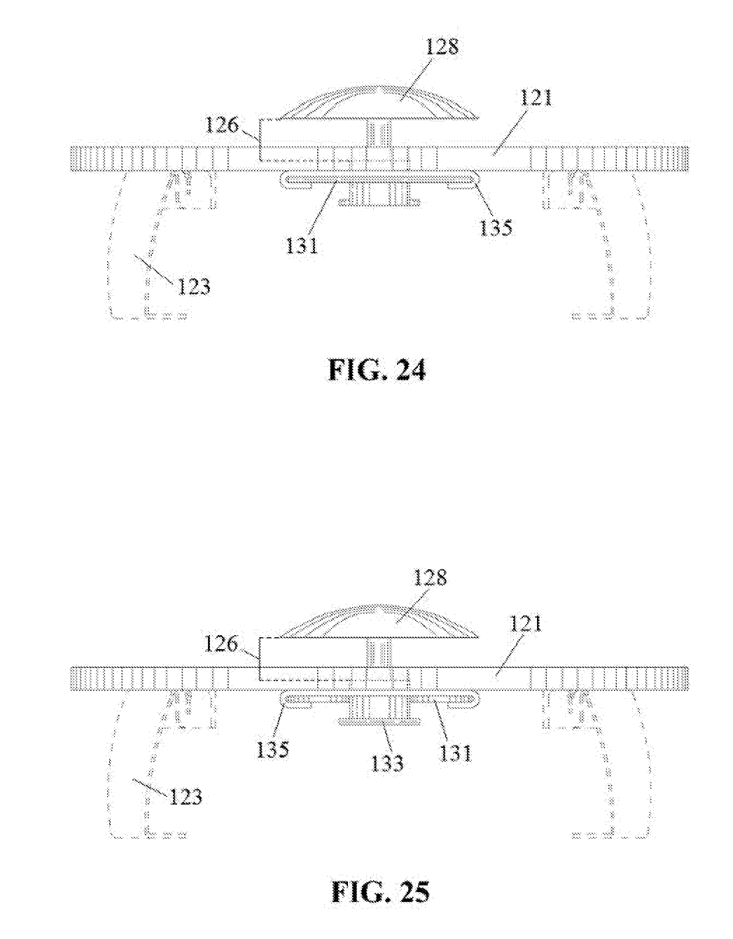

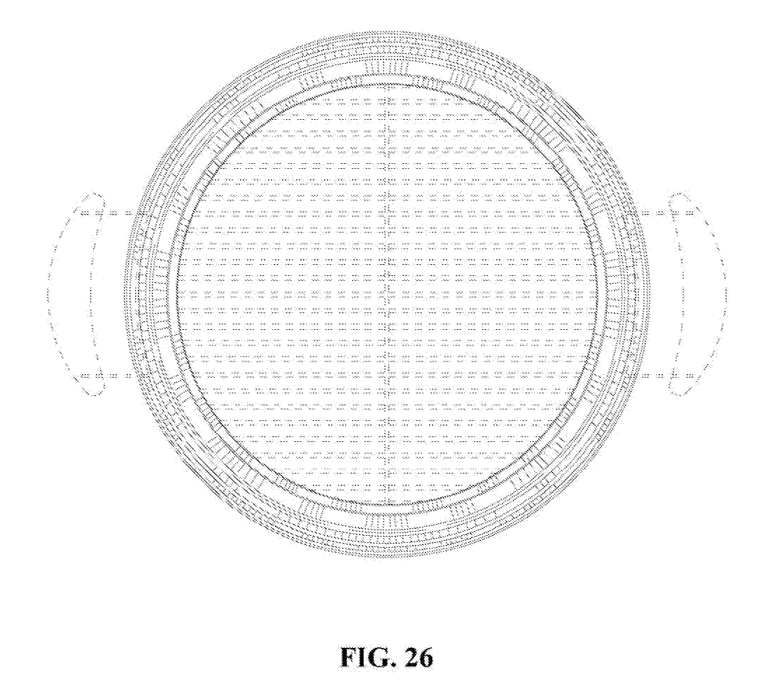

The separate base subassembly 120 may include a specialized damper 130 for regulating the airflow through the central air intake 129. The damper 130 may be an adjustable mechanism operable to cover the central air intake 129 to varying extents, allowing the user to adjust the amount of air flowing through the central air intake 129. The damper 130 may be operable to adjust the area of the central air intake 129 with continuous discrete settings between 0% and 100% of the area of the air intake vent. Referring to the exemplary embodiment of FIG. 5, it is seen that in this embodiment the damper 130 may include a slidable plate 131 having a damper hole 132 therein that has the same or substantially the same diameter as the central air intake vent 129. The centers of the central air intake hole 129 and the damper hole 132 may be aligned along the sliding path of the damper plate 131. The damper plate 131 may be slidably mounted in a receiver 135 having slots that overlap and engage with the lateral edges of the damper plate 131. An end pin 139 may be provided to prevent plate 131 from exiting receiver 135. The damper 130 may have a handle 133 that protrudes laterally from the bottom of the assembled cooker 100 (see, e.g., FIG. 11A) to allow the user easy access to adjust the position of the damper plate 131 and the proportion of the air intake hole 129 occluded by the damper plate 131.

The handle 133 of the damper 130 may have markings 136 thereon to indicate the position of the damper hole 132 in the damper plate 131 relative to the central air intake hole 129. For example and without limitation, the handle 133 may include markings 136 that indicate the fraction or percentage (e.g., a range of 1/10 to 1/1, a range of 0% to 100%, etc.) of the central air intake that remains open as the damper handle is pushed toward or pulled away from the barrel cooker, where the proportion of the air intake that is occluded is indicated by the number marking that is visible immediately adjacent to the outer perimeter of the barrel cooker.

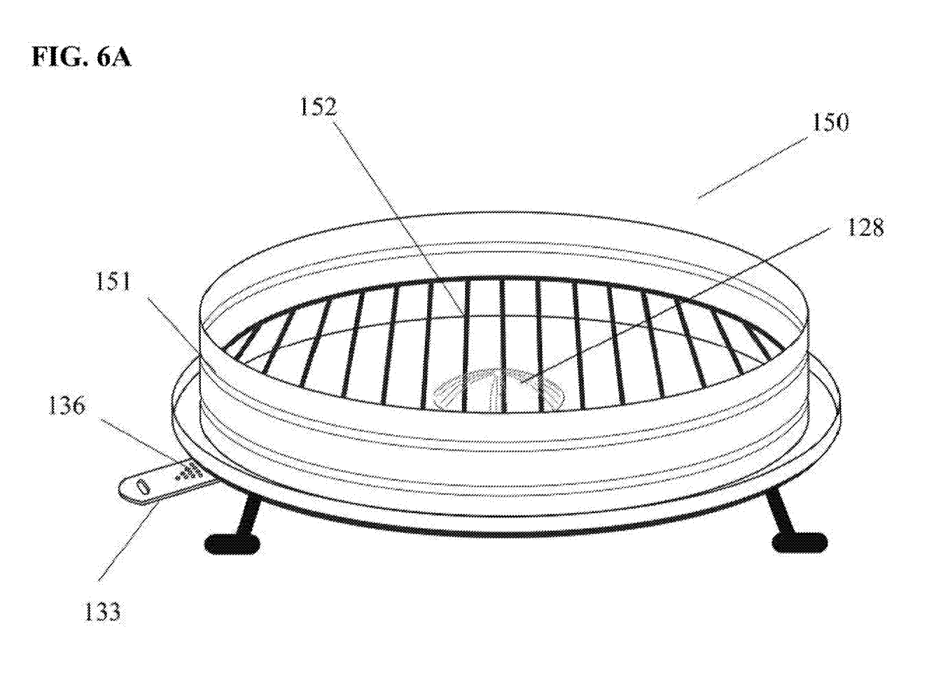

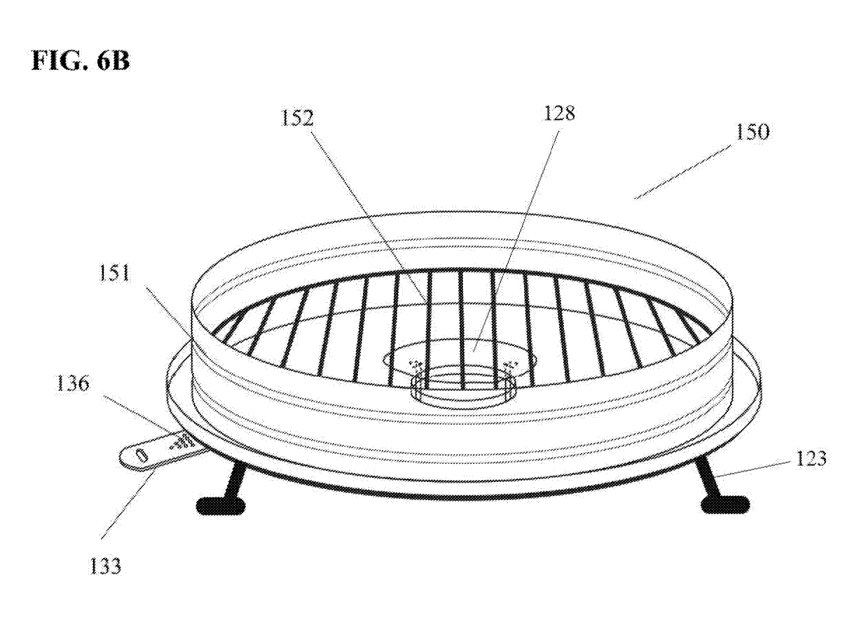

The cooker 100 includes a heat source or heat source container, which may be a removable coal basket having an outer wall and a grate held therein. FIGS. 6A and 6B show embodiments of a coal basket 150 having a cylindrical outer wall or shroud 151 and a coal grate 152 positioned horizontally therein. The coal basket may hold various fuels (e.g., charcoal, wood, etc.) as a heat source for cooking. The amount of the fuel may be provided in particular amounts by the user for the purpose of providing a particular length of cooking time, depending on the food to be cooked (e.g., a longer cooking time and more fuel may be required for a roast or turkey, in contrast to carved steaks).

In some embodiments, and without limitation, the volume within the coal basket 150 above the grate may be configured to hold a pre-determined discrete amount of a fuel (e.g., charcoal, wood, etc.) that allows for a particular cooking duration. In the embodiment shown in the figures, the coal basket has two distinct coal basket volumes—one on either side of the coat grate 152. The user need only flip the coal basket 150 over to switch between the volumes. For example and without limitation, the first volume (the larger volume) may be calibrated to provide a consistent temperature within the system for a longer duration (in a range of about 5 to 7 hours, e.g., about 6 hours) in a relatively tight, controlled range that may vary, for example, by about 50° F. or less (e.g., in a range of about 275° F. to about 325° F.), for cooking meats and other foods that require high cooking temperatures. Such an exemplary cooking time is consistent for the pre-determined amounts with deviations of about 30 minutes or less that may result the fuel quality and the shape of the fuel (e.g., briquettes vs. wood lump charcoal), which may affect the mass of fuel that can be added to the coal basket. In this example, the second volume (the smaller volume) is calibrated to provide a consistent temperature within the system for a shorter duration (in a range of about 3 to 5 hours, e.g., about 4 hours) in a relatively tight, controlled range that may vary by about 50° F. or less (e.g., in a range of about 275° F. to about 325° F.) for cooking fish and other foods that can be prepared in a shorter cooking time. It is to be appreciated that other variations in the volume of heat producing fuel are possible by changing the location of grate 152, by adding more or less fuel to the basket 150, etc.

The coal basket 150 may be configured such that the shroud 151 holds the grate 152 above the diffuser 128 with a vertical gap in the range of about 1 inch to about 5 inches (e.g., about 2 inches to about 4 inches, or any value or range of values therein). The diffuser 128 may deflect air entering the vessel outward from center in a controlled manner, such that a widened column of air (e.g., having a diameter in a range of about 10 inches to about 20 inches) passes through fuel held in the coal basket 150. The air is then heated, providing a widened column of hot air to evenly cook food in the vessel.

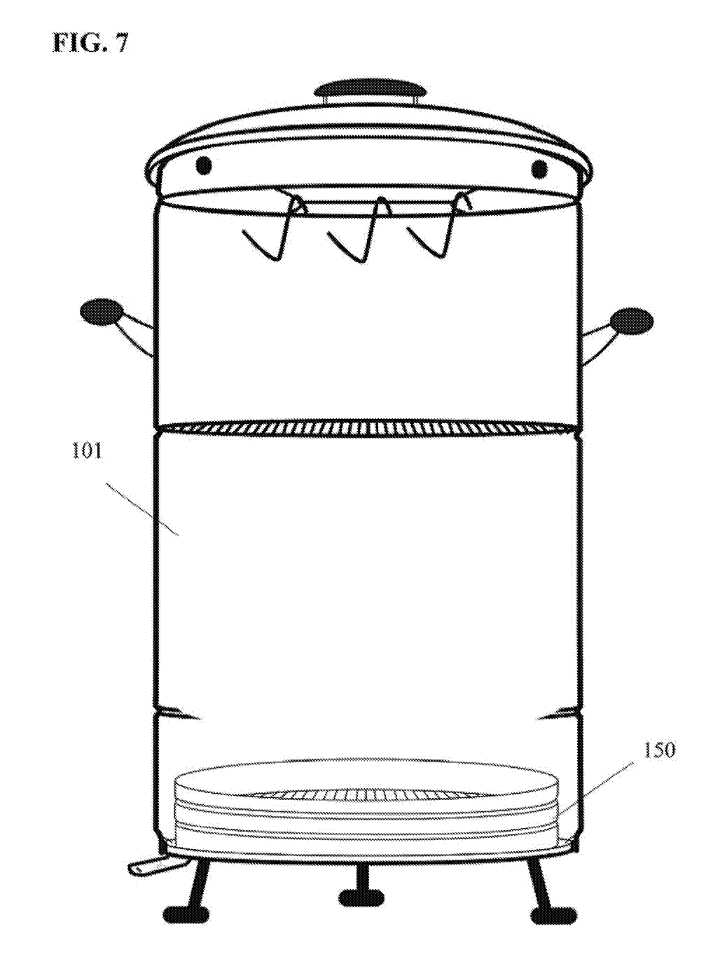

The coal basket 150 may be positioned within the cooker 100 on the separate base, such that it can be easily accessed by removing the vessel 101 so that basket 150 may be removed for cleaning or flipped over such that either side of the coal grate 152 may be positioned in an upward facing manner within the cooker, as shown in FIG. 7.

The present invention also includes a system of modular and adjustable grill racks, smoking hooks, and cooking surfaces that allow the user more control and variation of the placement and cooking methods for various food items. The cooking system of the present invention offers multiple cooking options, in contrast to conventional outdoor cooking systems that have a single grill or only meat hangers. The adjustable modular cooking surface or hanger components are removable and can be arranged and adjusted within the cooking system for specific and customized cooking purposes. The accessories include multiple circular support racks that are operable to rest on the accessory beads within the body of the system. The support racks may have detents along their perimeters that reduce the radius of the rack at the detent so that the racks can be lowered into the body of the cooking system through the top of the body. The modular grills, grates, and other accessory structures can be positioned on the support racks once the racks are positioned on the accessory beads. The accessories may also include a specialized wand have an angled distal end and a loop at the distal end that can be used to install and remove the support racks, and the other accessories in the body. The accessories of the presently disclosed outdoor cooking system can then be easily removed from the vessel and washed due to their modular, adjustable configuration and relatively small size and easily cleaned (e.g., in a dishwasher).

Embodiments of vessel 101 may also include accessory beads 109 at various cross-sectional planes of the vessel 101. The accessory beads 109 are concave grooves that may run all or part of the circumference of the vessel 101 and intrude into the interior circumference of the vessel 101 at various cross-sectional planes for the purpose of mounting structures for holding food items within the cooker 100 during cooking operation. The frames, grates, and other accessories that are engaged with the accessory beads 109 are discussed in detail below.

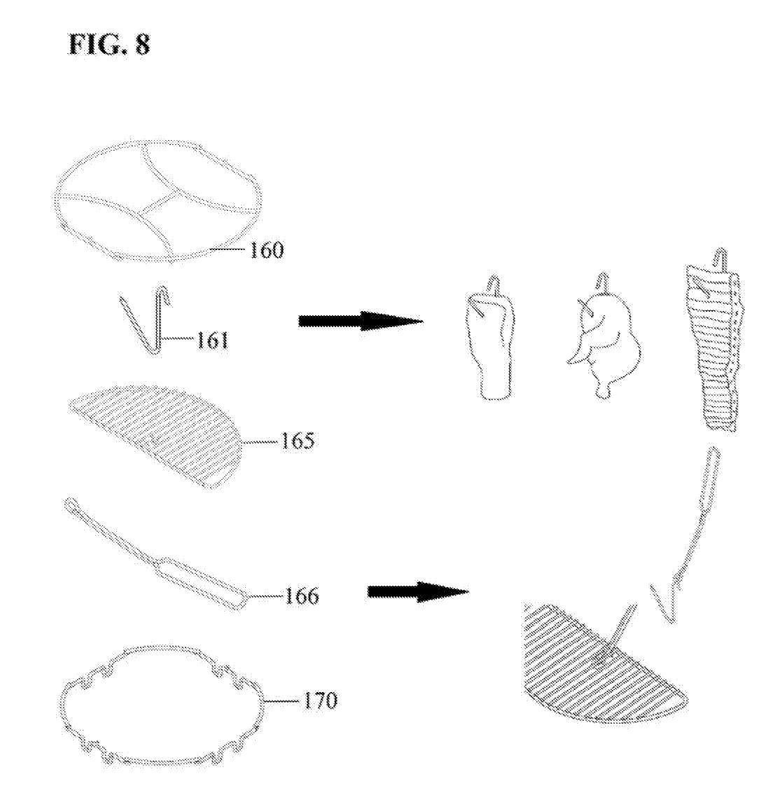

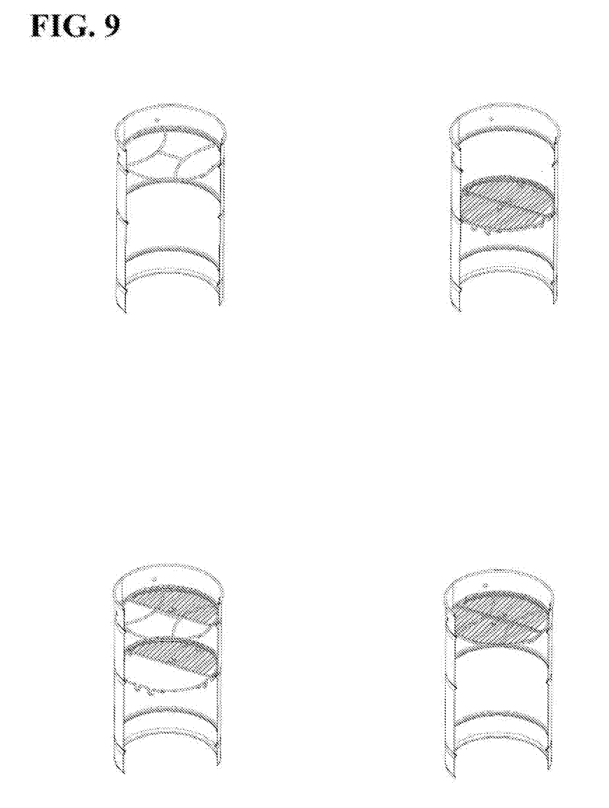

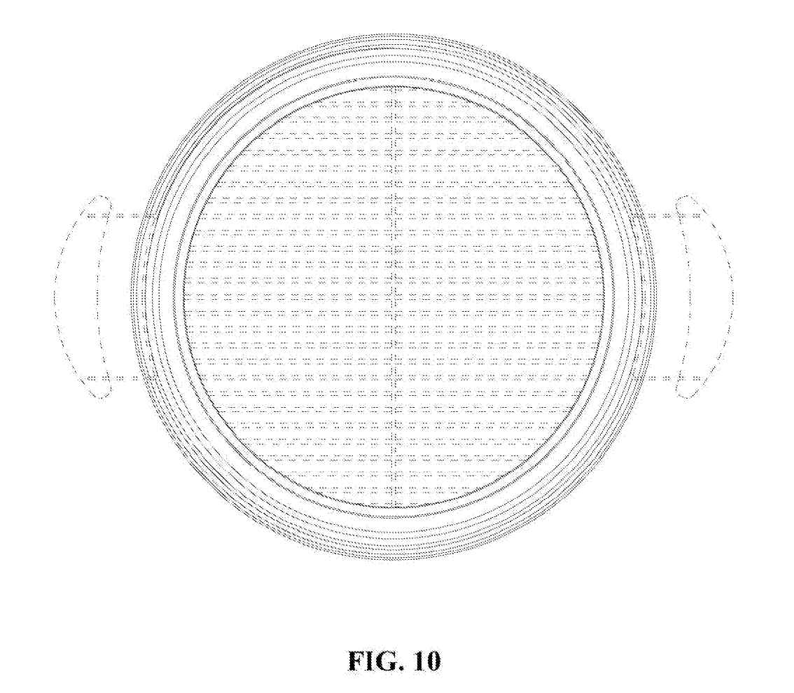

FIGS. 8-9 show accessory structures that may be included in exemplary barrel-shaped embodiments of the cooking system of the present invention. The accessory system may include an H-frame 160, which is a spread “H”-shaped device that allows for the suspension hooks 161 to be hung therefrom in multiple locations. The suspension hooks 161 can be used to suspend racks of ribs and other meats and food items. A turkey hanger assembly may also be suspended on the H-frame 160. The H-frame 160 includes “D” shaped detents on opposing outer edges that may act as handles but also allow the H-frame 160 to be lowered in the barrel vessel 101 to multiple levels.

As discussed above, the barrel-shaped versions of vessel 101 may include multiple accessory beads 109 that may support the H-frame 160. In order for the H-frame 160 to be operable to be lowered into the interior of the barrel vessel 101 past one or more accessory beads, and yet have a sufficient diameter to be supported by the accessory beads, H-frame cannot have a round perimeter. The H-frame 160 includes the detents so that it can be lowered past one or more accessory beads to the desired level in the barrel vessel 101.

The accessory system may also include an open frame 170, which may be a circular frame sufficiently large that it can rest on and be supported by one of the accessory beads. The open frame 170 may be configured to mate with one or two half-moon-shaped grill grates 165 or other modular accessories (e.g., a half-moon griddle surface, etc.). The open frame 170 may also include “D”-shaped detents on the opposing outer edges that allow it to be lowered to any of the accessory beads 109. FIG. 9 shows several cut-away views of the interior of a barrel vessel 101, such that the H-frame 160 and the open frame 170 are shown supported in various positioned within the interior of the barrel vessel 101 on the accessory beads 109. The H-frame 160 and the open frame 170 may be used separately or together and can be moved to various heights in the barrel vessel 101 where accessory beads 109 are provided. The H-frame or a grill may also be used to support coal basket 150 at a location within the body of vessel 101.

The H-frame 160 and open frame 170 may have circumferences that are slightly smaller than the diameter of the barrel vessel 101 but sufficiently larger than the diameter of the inner circumference of the accessory beads 109, allowing the frames to rest on and be supported by the accessory beads. For example, the largest dimension of the H-frame 160 and open frame 170 (determined by the diameter of the barrel) may be in a range of about 8″ to about 18″. The detents provide areas of smaller diameter that allow the frames to fit inside the barrel below at any interior accessory beads 109.

The accessory system may also include several other “D-shaped” accessory pieces that fit into and/or engage with the H frame 160 and open frame 170. Such accessories can be used in pairs or singularly at various heights within the barrel vessel 101 either separately or simultaneously.

The half-grill grates 165 may be wire-form, nickel-plated grates that can suspend various foods in the interior of the barrel vessel 101. The accessory system may also include slotted half-grill grates, which may be stainless steel (or other appropriate materials) and have a semi-solid surface that may temper the heat flow in the barrel vessel 101, while the slots allow for sufficient heat passage and sufficiently drain excessive moisture from the grate that develops during the cook process. The grill grates may also contain detents for easy removal with a hook and modular accessory wand 166.

The accessory system may include a hook accessory wand 166 for engaging, manipulating, and moving the accessories into and out of the barrel vessel 101 and to disengage modular accessories from the open frame 170 or the H-frame 160 while avoiding any hot surfaces. The wand 166 may include a closed or partially closed loop at the distal end thereof for engaging with meat hangers or other accessories that can be slotted into the wand loop. The distal loop of the wand 166 may also be slotted into the wires or slots on the accessory grates to allow the user move the grates without the need to touch any hot surfaces. The wand 166 may have an obliquely angled distal end to allow the user to easily lift and lower the grates, once the distal loop of the wand 166 is slotted into the grates. The wand 166 may be made from a rigid material that is durable, and optionally having a relatively low thermal conductivity to prevent the transfer of significant heat from the distal end thereof to the handle or an insulative material over the handle portion of the wand 166.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A cooking device comprising:
a. a vessel for holding food items;
b. a base having a lower air intake, wherein the vessel is removably positioned over said base;
c. a deflection mechanism over said central air intake for deflecting air into the vessel; and
d. a removable basket for holding a heat source, the basket having a grate for holding the heat source over the central air intake and the deflection mechanism.

2. The cooking device of claim 1, wherein said deflection mechanism comprises a convex plate positioned above said central air intake such that the convexity of the convex plate is directed upward.

3. The cooking device of claim 2, further comprising a retaining wall surrounding said central air intake for preventing the passage of ash and other material through said central air intake from the interior of the cooking device.

4. The cooking device of claim 1, further comprising a damper for adjusting the rate of air flow into the vessel.

5. The cooking device of claim 4, wherein the damper is adjustably positioned below said central air intake and is operable to occlude a variable portion of the area of the central air intake.

6. The cooking device of claim 1, wherein said basket has an adjustable volume for holding a fuel.

7. The cooking device of claim 1, further comprising at least one exhaust hole near an upper end of the vessel.

8. The cooking device of claim 1, wherein said vessel includes a plurality of support rims for supporting a grill or frame for positioning food inside said vessel.

9. The cooking device of claim 1, further comprising a lid operable to create an air-tight seal with an upper end of said vessel.

10. The cooking device of claim 1, wherein said base includes a vertically extending wall near an outer perimeter thereof.

11. The cooking device of claim 10, wherein said vessel includes an angled peripheral flange at a bottom end thereof for engagement against said vertically extending wall of said base to support said vessel above said base.

12. The cooking device of claim 11, wherein said vessel includes a gasket on said angled flange for creating a seal between the angled flange and the vertically extending wall of the base.

13. The cooking device of claim 1, wherein the central air intake is a single hole having an isoperimetric quotient of 0.7 or higher.

14. The cooking device of claim 1, wherein the central air intake comprises a plurality of holes and/or slots arranged in a compact pattern.

15. The cooking device of claim 1, wherein the basket is removable to facilitate loading and dumping of the fuel.

16. The cooking device of claim 7, wherein said vessel includes four exhaust holes spaced at 90° intervals around the perimeter of the vessel.

17. The cooking device of claim 8, wherein said support rims comprise at least one bead protruding inwardly from the perimeter of the vessel.

18. The cooking device of claim 1 further comprising a plurality of legs for supporting said base.

19. The cooking device of claim 5 wherein said damper further comprises a handle which protrudes beyond the outer perimeter of said base.

20. The cooking device of claim 11 further comprising a peripheral rim at the bottom edge of said vessel for nesting over said vertically extending wall of said base.

21. A portable cooker comprising:
a. a hollow vertically oriented vessel having an open upper end, an open lower end, at least one vent opening in an upper region thereof, and an angled peripheral flange at said lower end;
b. a corresponding base for receiving the lower end of said vessel, said base having a generally horizontal lower surface and an upwardly extending wall along a peripheral edge of the surface for engagement against the peripheral flange of said vessel;
c. an air intake opening in the generally horizontal surface of said base, said opening having an upwardly extending lip along a peripheral edge thereof;
d. a diffuser provided above the air intake opening, a gap between said diffuser and said opening, the diffuser being supported by at least one leg and having a perimeter that is larger than said opening;
e. a movable damper provided below said air intake opening;
f. a removable fuel basket for placement on said base; and
g. a lid for closing the upper end of said vessel.

22. The cooker of claim 21 further comprising a gasket provided on said peripheral flange for creating a seal between the flange and the upwardly extending wall of the base.

23. The cooker of claim 21 further comprising a peripheral rim at the bottom edge of said vessel for nesting over said vertically extending wall of said base.

24. The cooker of claim 21 wherein said damper further comprises an opening and a handle wherein said opening is adjustably positioned below the air intake opening in said base and is operable to occlude a variable portion of the area of said air intake opening.

25. The cooker of claim 21 wherein said coal basket further comprises a movable grate for supporting fuel in said basket above said diffuser.

26. A portable cooker comprising:
a. a hollow cylindrical vertically oriented drum having an open upper end, an open lower end, at least one vent opening in an upper region thereof, and an angled annular flange at said lower end;
b. a circular base for receiving the lower end of said drum, said base having a generally horizontal surface and an upwardly extending outer cylindrical wall along a peripheral edge of the surface for engagement against the annular flange of said drum;
c. an air intake opening in the generally horizontal surface of said base, said opening having an upwardly extending circumferential wall along a peripheral edge thereof such that a basin is formed between said cylindrical rim and said lip;
d. a dome shaped diffuser provided above the air intake opening, a gap between said diffuser and said opening, the diffuser being supported by at least one leg and having a diameter that is larger than said opening;
e. a movable damper provided below said air intake opening;
f. a removable fuel basket for placement on said base; and
g. a lid for closing the upper end of said drum.

27. The cooker of claim 26 further comprising an annular gasket provided on said annular flange for creating a seal between the flange and the upwardly extending wall of the base.

28. The cooker of claim 26 further comprising a peripheral rim at the bottom edge of said vessel for nesting over said vertically extending wall of said base.

29. The cooker of claim 26 wherein said damper further comprises an opening and a handle wherein said opening is adjustably positioned below the air intake opening in said base and is operable to occlude a variable portion of the area of said air intake opening.

30. The cooker of claim 26 wherein said coal basket further comprises a movable grate for supporting fuel in said basket above said diffuser.

31. A method for cooking food on a portable vertical cooker comprising the steps of:
a. placing fuel in a basket having a grate for supporting said fuel;
b. placing said basket on a base, said base comprising
i. a generally horizontal lower surface and an upwardly extending wall along a peripheral edge of the surface;
ii. an air intake opening in the generally horizontal surface of said base, said opening having an upwardly extending lip along a peripheral edge thereof;
iii. a diffuser provided above the air intake opening, a gap between said diffuser and said opening, the diffuser being supported by at least one leg and having a perimeter that is larger than said opening; and
iv. a movable damper provided below said air intake opening;
c. adjusting said damper;
d. lighting said fuel;
e. engaging said vessel with said base, said vessel comprising an open upper end, an open lower end, at least one vent opening in an upper region thereof, and an angled peripheral flange at said lower end for engagement with said upwardly extending wall of said base;
f. closing the upper end of said vessel with a lid;
g. allowing the interior of said vessel to reach a desire temperature;
h. opening the lid;
i. placing said food on a hook or grill suspended in said vessel; and
j. closing the lid.

32. The method of claim 31 comprising the additional steps of:
l. leaving the food in the closed vessel for a predetermined period of time;
m. after said time period, opening the lid; and
n. removing the cooked food.
